(19) United States
(12) Patent Application Publication
(10) Pub. No.: US 2026/0194764 A1
(43) Pub. Date: Jul. 9, 2026

(54) IMAGING OPTICAL SYSTEM AND IMAGE PICKUP APPARATUS HAVING THE SAME

(71) Applicant: CANON KABUSHIKI KAISHA, Tokyo (JP)

(72) Inventor: Daisuke ITO, Tochigi (JP)

(21) Appl. No.: 19/556,262

(22) Filed: Mar. 4, 2026

Related U.S. Application Data
(63) Continuation of application No. PCT/JP2024/029145, filed on Aug. 16, 2024.

(30) Foreign Application Priority Data
Oct. 16, 2023 (JP) 2023-177995

(51) Int. Cl. G02B 27/28; G02B 9/62; G02B 9/64

(52) U.S. Cl. CPC G02B 27/286; G02B 9/62; G02B 9/64

(57) ABSTRACT

An imaging optical system may include an aperture stop, a first transmissive reflective surface, a quarter waveplate, and a second transmissive reflective surface. The first transmissive reflective surface, the quarter waveplate, and the second transmissive reflective surface may be arranged in order from an object side to an image side. Light from the object side sequentially may transmit through the first transmissive reflective surface and the quarter waveplate, be reflected toward the object side by the second transmissive reflective surface, transmit through the quarter waveplate, be reflected toward the image side by the first transmissive reflective surface, and sequentially transmit through the quarter waveplate and the second transmissive reflective surface toward the image side.

### CROSS-REFERENCE TO RELATED APPLICATIONS

This application is a Continuation of International Patent Application No. PCT/JP2024/029145, filed on Aug. 16, 2024, which claims the benefit of Japanese Patent Application No. 2023-177995, filed on Oct. 16, 2023, both of which are hereby incorporated by reference herein in their entirety.

### BACKGROUND

### Field of the Technology

The present disclosure relates to an imaging optical system and an image pickup apparatus having the same.

### Description of the Related Art

A configuration known as a Gaussian type has conventionally been known for achieving a large-diameter lens using a small number of lenses. However, correcting the coma flare in the sagittal direction that occurs with this configuration results in significant curvature of field on the underside. In a case where a lens with strong negative refractive power is disposed just before the image sensor to correct the significant curvature of field on the underside, light rays that pass through the negative lens will enter the image sensor at a large angle relative to the optical axis, resulting in so-called ray shielding by the image sensor and resulting in a darker image toward the periphery.

Optical systems have recently been proposed that utilize polarization to control reflections and transmissions on lens surfaces. Japanese Patent Application Laid-Open No. 2005-352273 discloses a configuration that utilizes surface reflections within the lenses, with two to three lenses. Japanese Patent Application Laid-Open No. 2013-218078 discloses a configuration that utilizes surface reflections within the lenses, allowing switching from an imaging system to an observation system by rearranging lenses near the reflective surface located on the image side while keeping the front lens unit common.

### SUMMARY

An imaging optical system according to one aspect of the present disclosure may include an aperture stop, a first transmissive reflective surface, a quarter waveplate, and a second transmissive reflective surface. The first transmissive reflective surface, the quarter waveplate, and the second transmissive reflective surface may be arranged in order from an object side to an image side. Light from the object side sequentially may transmit through the first transmissive reflective surface and the quarter waveplate, be reflected toward the object side by the second transmissive reflective surface, transmit through the quarter waveplate, be reflected toward the image side by the first transmissive reflective surface, and sequentially transmit through the quarter waveplate and the second transmissive reflective surface toward the image side. The following inequalities may be satisfied:

$$\begin{matrix}2.2 \leq L / Lh \leq 10 \; 0.0 \\ 0.15 \leq D / LD \leq 2. 00\end{matrix}$$

where L is an overall optical length, Lh is a distance on an optical axis from the first transmissive reflective surface to an image plane, D is a maximum aperture diameter of the aperture stop, and LD is a distance on the optical axis from the aperture stop to the image plane. An image pickup apparatus having the above imaging optical system also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an optical path of an optical system.

FIG. 2 is a schematic diagram illustrating the optical path of the optical system.

FIG. 3 is a sectional view of an imaging optical system according to Example 1.

FIG. 4 is an aberration diagram of the imaging optical system according to Example 1 in an in-focus state at infinity.

FIG. 5 is a sectional view of an imaging optical system according to Example 2.

FIG. 6 is an aberration diagram of the imaging optical system according to Example 2 in an in-focus state at infinity.

FIG. 7 is a sectional view of an imaging optical system according to Example 3.

FIG. 8 is an aberration diagram of the imaging optical system according to Example 3 in an in-focus state at infinity.

FIG. 9 is a sectional view of an imaging optical system according to Example 4.

FIG. 10 is an aberration diagram of the imaging optical system according to Example 4 in an in-focus state at infinity.

FIG. 11 is a sectional view of an imaging optical system according to Example 5.

FIG. 12 is an aberration diagram of the imaging optical system according to Example 5 in an in-focus state at infinity.

FIG. 13 is a sectional view of an imaging optical system according to Example 6.

FIG. 14 is an aberration diagram of the imaging optical system according to Example 6 in an in-focus state at infinity.

FIG. 15 is a sectional view of an imaging optical system according to Example 7 at a wide-angle end.

FIGS. 16A, 16B, and 16C illustrate sectional views and moving loci from the wide-angle end to a telephoto end of the imaging optical system according to Example 7 in an in-focus state at infinity.

FIG. 17 is an aberration diagram of the imaging optical system according to Example 7 at a wide-angle end in an in-focus state at infinity.

FIG. 18 is an aberration diagram at an intermediate zoom position of the imaging optical system according to Example 7 in an in-focus state at infinity.

FIG. 19 is an aberration diagram of the imaging optical system according to Example 7 at a telephoto end in an in-focus state at infinity.

FIG. 20 is a sectional view of an imaging optical system according to Example 8 at a wide-angle end.

FIGS. 21A, 21B, and 21C illustrate sectional views and moving loci of the imaging optical system according to Example 8 from a wide-angle end to a telephoto end in an in-focus state at infinity.

FIG. 22 is an aberration diagram of the imaging optical system according to Example 8 at a wide-angle end in an in-focus state at infinity.

FIG. 23 is an aberration diagram of the imaging optical system according to Example 8 at an intermediate zoom position in an in-focus state at infinity.

FIG. 24 is an aberration diagram of the imaging optical system according to Example 8 at a telephoto end in an in-focus state at infinity.

FIG. 25 is a sectional view of an imaging optical system according to Example 9 at a wide-angle end.

FIGS. 26A, 26B, and 26C illustrate sectional views and moving loci of the imaging optical system according to Example 9 from a wide-angle end to a telephoto end in an in-focus state at infinity.

FIG. 27 is an aberration diagram of the imaging optical system according to Example 9 at a wide-angle end in an in-focus state at infinity.

FIG. 28 is an aberration diagram of the imaging optical system according to Example 9 at an intermediate zoom position in an in-focus state at infinity.

FIG. 29 is an aberration diagram of the imaging optical system according to Example 9 at a telephoto end in an in-focus state at infinity.

FIG. 30 is a sectional view of an imaging optical system according to Example 10 at a wide-angle end.

FIGS. 31A, 31B, and 31C illustrate sectional views and moving loci of the imaging optical system according to Example 10 from the wide-angle end to a telephoto end in an in-focus state at infinity.

FIG. 32 is an aberration diagram of the imaging optical system according to Example 10 at a wide-angle end in an in-focus state at infinity.

FIG. 33 is an aberration diagram of the imaging optical system according to Example 10 at an intermediate zoom position in an in-focus state at infinity.

FIG. 34 is an aberration diagram of the imaging optical system according to Example 10 at a telephoto end in an in-focus state at infinity.

FIG. 35 is a sectional view of an imaging optical system according to Example 11.

FIG. 36 is an aberration diagram of the imaging optical system according to Example 11 in an in-focus state at infinity.

FIG. 37 is a sectional view of an imaging optical system according to Example 12.

FIG. 38 is an aberration diagram of the imaging optical system according to Example 12 in an in-focus state at infinity.

FIG. 39 is an explanatory diagram of an outermost off-axis ray passing through a center of an aperture stop.

FIG. 40 is a schematic diagram of an image pickup apparatus.

### DESCRIPTION OF THE EMBODIMENTS

Referring now to the accompanying drawings, a detailed description will be given of examples according to the present disclosure. Corresponding elements in respective figures will be designated by the same reference numerals, and a duplicate description thereof will be omitted.

An imaging optical system according to each example is an optical system that images an object on an image plane, and is an optical system for acquiring an image by a solid-state image sensor, a photosensitive film, or the like disposed on the image plane.

The imaging optical system according to each example can be used in an image pickup apparatus such as a smartphone imaging camera, a distance-detecting camera, a lens fixed camera, or a disposable film camera, each including an image sensor that receives an image formed by the imaging optical system. The imaging optical system according to each example can also be used as a video camera, a digital still camera, and or an interchangeable lens for a lens interchangeable type camera.

The imaging optical system according to each example may be used in a camera viewfinder or an XR device for, for example, line-of-sight detection, biometric authentication, facial expression recognition, or the like. The imaging optical system according to each example may also be used for external environment recognition in an XR device, an autonomous robot, or the like.

The imaging optical system according to each example includes an aperture stop, a first transmissive reflective surface, a quarter waveplate (QWP), and a second transmissive reflective surface. The first transmissive reflective surface, the quarter waveplate, and the second transmissive reflective surface are arranged in order from an object side to an image side. The maximum aperture refers to a state in which an aperture stop is fully opened. In each example, a state in which the aperture stop is fully opened is defined as a maximum aperture value, and, in this state, a width of an on-axis light beam is determined by a maximum aperture diameter. In a lens system that does not include an aperture stop with a variable stop aperture, an aperture that defines an on-axis light beam may be defined as the maximum aperture. In a case where an aperture that defines an on-axis light beam falls within a range of inequality (3) described later, that aperture is defined as the maximum aperture. Light from the object side sequentially transmits through the first transmissive reflective surface and the QWP, and is reflected by the second transmissive reflective surface. Thereafter, the light transmits through the QWP, is reflected by the first transmissive reflective surface, and then transmits through the QWP and the second transmissive reflective surface to travel toward an imaging unit including a solid-state image sensor, a photosensitive film, or the like.

Here, the first transmissive reflective surface and the second transmissive reflective surface may not have a transmittance of 50% and a reflectance of 50%. A ratio between transmittance and reflectance for randomly polarized light may be within a range from 1:3 to 3:1. Randomly polarized light refers to light having Stokes parameters of S0=1 and S1=S2=S3=0. The first transmissive reflective surface and the second transmissive reflective surface may absorb light.

A lens may be formed or cemented on one side or both sides of each transmissive reflective surface.

The QWP can use, for example, a polymer film having birefringence or a liquid crystal alignment layer. A laminate of such polymer films or liquid crystal alignment layers may also be used as the QWP. By properly laminating these layers, a phase difference close to the quarter wavelength can be obtained over a wide wavelength range. The QWP can use, in addition to the above, for example, an inorganic wave plate manufactured by Dexerials Corporation.

The QWP can be disposed, for example, by being bonded to the first transmissive reflective surface or the second transmissive reflective surface. Alternatively, the QWP can be disposed as a separate member from these transmissive reflective surfaces. For example, a film may be directly inserted into an optical path, or a film bonded to a glass plate may be inserted into the optical path. A lens may be formed or bonded on one side or both sides of the QWP. For example, by using an inorganic wave plate as a substrate, a lens may be molded on one side or both sides of the inorganic wave plate using wafer-level optics technology.

Next, characteristic configurations of the imaging optical system according to each example will be described.

The imaging optical system according to each example may satisfy the following inequalities (1) and (2):

$$2.2 \leq L / Lh \leq 10 \; 0.0 \qquad ( 1 )$$

$$0.15 \leq D / LD \leq 2. 00 \qquad ( 2 )$$

Here, L is an overall optical length, which is a distance on the optical axis from an optical surface closest to the object to the image plane. Lh is a distance along an optical axis from the first transmissive reflective surface to the image plane. D is a maximum aperture diameter of the aperture stop. LD is a distance on the optical axis from the aperture stop to the image plane.

Inequality (1) defines a position of the first transmissive reflective surface relative to the overall optical length, and represents at which position within an entire lens system (the imaging optical system) an incident angle of an off-axis ray relative to the optical axis is relaxed when the off-axis ray enters the image sensor. By defining the distance along the optical axis from the first transmissive reflective surface to the image plane, inequality (1) leads to regulation of a light beam width passing through the first transmissive reflective surface, thereby representing enhanced optical performance. In a case where the distance along the optical axis from the first transmissive reflective surface to the image plane becomes longer than the lower limit of inequality (1), the overall lens length becomes excessively large. In addition, since the entire lens system separates from the image sensor, an incident angle onto the image sensor becomes excessively steep, and it becomes difficult to satisfy incident angle constraints. A light beam width passing through front and rear surfaces adjacent to the first transmissive reflective surface increases, thereby increasing an aberration amount generated when passing through these surfaces. On the other hand, in a case where the value becomes higher than the upper limit of inequality (1), an incident angle onto the image sensor can be more easily accommodated; however, a final surface of the entire lens system interferes with the image sensor.

Inequality (2) defines an maximum aperture diameter of the aperture stop that determines an on-axis Fno light beam diameter and a distance along the optical axis from the aperture stop to the image plane. When a region having a strong negative refractive power is present near a center of the entire lens system, a portion in which an on-axis light beam becomes thicker than an on-axis light beam diameter at an aperture stop position (corresponding to the maximum aperture diameter) appears at a position closer to an image plane than (on the image side of) the aperture stop. In a case where the negative refractive power is strong and coma flare in the sagittal direction is significantly generated, the value of inequality (2) becomes smaller as compared with a case where the negative refractive power is weak and coma flare in the sagittal direction is well corrected. In a case where the negative refractive power within the entire lens system is weak and coma flare in the sagittal direction is well corrected, an on-axis light beam gradually becomes thinner than the maximum aperture diameter at a position closer to the image plane than the aperture stop, and thus the value of inequality (2) becomes larger. Thus, inequality (2) can be regarded as defining brightness expressed by Fno and a negative refractive power within the entire lens system. In a case where the value of inequality (2) becomes the lower limit of inequality (2), a target F-number becomes darker in specification, or the negative refractive power within the entire lens system becomes stronger, thereby increasing coma flare in the sagittal direction. In a case where the value becomes higher than the upper limit of inequality (2), brightness increases and coma flare in the sagittal direction is satisfactorily corrected; however, excessive brightness prevents reduction in lens size and achieving high performance.

Simultaneously satisfying inequalities (1) and (2) can achieve a large-aperture lens in which negative refractive power within the entire lens system is weak, an incident angle onto an image sensor is relaxed, and high optical performance is achieved.

The numerical ranges of inequalities (1) and (2) may be set to the numerical ranges of inequalities (1a) to (2a) below:

$$2.3 \leq L / LH \leq 85. \qquad ( 1 a )$$

$$0.21 \leq D / LD \leq 1.5 \qquad ( 2 a )$$

The numerical ranges of inequalities (1) and (2) may be set to the numerical ranges of inequalities (1b) to (2b) below:

$$2.4 \leq L / LH \leq 70. \qquad ( 1 b )$$

$$0.21 \leq D / LD \leq 1.5 \qquad ( 2 b )$$

Next, configurations that the imaging optical system according to each example may satisfy will be described.

One of the first transmissive reflective surface and the second transmissive reflective surface may be a surface that separates incident light into reflected light and transmitting light according to a polarization state. More specifically, as described below, a polarization-selective transmissive reflective element may be used as one of the first transmissive reflective surface and the second transmissive reflective surface. Examples of the polarization-selective transmissive reflective element include products sold under the trade name “WGF” by Asahi Kasei Corporation and products sold under the trade name “IQPE” by 3M Company. Alternatively, an optical element formed by forming a grid on a lens reflective surface during lens molding and depositing, printing, or lithographically forming a metal or dielectric layer thereon may be used. The other surface can use a half-mirror, a cholesteric liquid crystal, or a holographic optical element. In a case where a half-mirror is used, the amount of randomly polarized light incident from an object side becomes 12.5% or less by the time the light reaches the image plane. Using a cholesteric liquid crystal or a holographic optical element, the amount of light on the image plane can be significantly increased, for example, to about twice that obtained in a case where the half-mirror is used.

The imaging optical system according to each example may be rotationally symmetric about an optical axis.

At least one of the first transmissive reflective surface and the second transmissive reflective surface may be a planar surface. Thereby, manufacturing of the imaging optical system can be easier.

A region from an object-side lens surface of a negative lens disposed adjacent to and closer to the object than (on the object side of) the first transmissive reflective surface to the second transmissive reflective surface may be formed of a glass medium, that is, may be configured as an integrated cemented lens. Thereby, lens assembly can become simple.

A region from the object-side lens surface of the negative lens adjacent to and close to object than the first transmissive reflective surface to the second transmissive reflective surface is disposed at a position closest to the image sensor in the lens system. Although ghosting may occur due to this arrangement, in order to suppress ghosting, the shape from the object-side lens surface of the negative lens adjacent to and close to object than the first transmissive reflective surface to the second transmissive reflective surface may include a surface that is convex toward an image side.

The region from the object-side lens surface of the negative lens adjacent to and closer to the object than the first transmissive reflective surface to the second transmissive reflective surface may be disposed closer to the image plane than the aperture stop and may be disposed as close as possible to the image sensor where a light beam width becomes small. In a case where this region is disposed at a position where the light beam is thick, changes in surface shape relative to the light beam may affect aberrations.

Next, the conditions that the imaging optical system according to each example may satisfy will be described. The imaging optical system according to each example may satisfy one or more of inequalities (3) to (16) below:

$$0.35 \leq LD / L \leq 0.85 \qquad ( 3 )$$

$$1.2 \leq θ 2 / θ 1 \leq 20. \qquad ( 4 )$$

$$2. \leq fP / f \leq 15. \qquad ( 5 )$$

$$1.45 \leq nd \leq 2.3 \qquad ( 6 )$$

$$1. \leq L / Li \leq 200. \qquad ( 7 )$$

$$- 1. \leq fN / fP \leq - 0.1 \qquad ( 8 )$$

$$- 10. \leq fN / f \leq - 0.3 \qquad ( 9 )$$

$$- 1. \leq ( R 1 - R 2 ) / ( R 1 + R 2 ) \leq 0.3 \qquad ( 10 )$$

$$- 30. \leq fF / f \leq - 0.3 \qquad ( 11 )$$

$$0.65 \leq nd / ndN \leq 1.1 \qquad ( 12 )$$

$$0.01 \leq d / L \leq 0.15 \qquad ( 13 )$$

$$0.01 \leq Lh / f \leq 0.9 \qquad ( 14 )$$

$$0.3 \leq Oe / Ie \leq 4. \qquad ( 15 )$$

$$0.5 \leq Fno \leq 8. \qquad ( 16 )$$

Here, θ1 is an angle relative to the optical axis at which an outermost off-axis ray passing through the center of the aperture stop is incident on the first transmissive reflective surface. θ2 is an angle relative to the optical axis after the outermost off-axis ray passing through the center of the aperture stop is reflected by the second transmissive reflective surface and then reflected by the first transmissive reflective surface. fp is a focal length of a structure surrounded between the first transmissive reflective surface and the second transmissive reflective surface disposed adjacent to and closer to the image plane than the first transmissive reflective surface. f is a focal length of the imaging optical system. nd is a refractive index of a material other than air filling a region between the first transmissive reflective surface and the second transmissive reflective surface. Li is a distance on the optical axis from the second transmissive reflective surface to an image plane. fN is a focal length of a negative lens disposed adjacent to and closer to the object than the first transmissive reflective surface. R1 is a radius of curvature of an object-side lens surface of the negative lens disposed adjacent to and closer to the object than the first transmissive reflective surface. R2 is a radius of curvature of the second transmissive reflective surface. fF is a focal length from the object-side lens surface of the negative lens disposed adjacent to and closer to the object than the first transmissive reflective surface to the second transmissive reflective surface. ndN is a refractive index of the negative lens disposed adjacent to and closer to the object than the first transmissive reflective surface. d is a distance on the optical axis from the object-side lens surface of the negative lens disposed adjacent to and closer to the object than the first transmissive reflective surface to the second transmissive reflective surface. Oe is an outer diameter of a lens disposed at a position closest to the object in the imaging optical system. Je is an outer diameter of a lens disposed at a position closest to the image plane in the imaging optical system.

Inequality (3) defines the position of the aperture stop within the entire imaging optical system and also defines the size of the imaging optical system. If the aperture stop is disposed near the center portion of the entire imaging optical system, the off-axis rays can pass through lenses before and after the aperture stop in a well-balanced manner about the aperture stop, thereby reducing the size of the entire imaging optical system. In a case where the value of inequality (3) becomes lower than the lower limit of inequality (3), the aperture stop approaches the image plane, which increases the front lens diameter and the size of the imaging optical system. Further, as the aperture stop approaches the image plane, an incident angle of light on the image sensor becomes excessively steep, and even if an attempt is made to relax the incident angle by reflection at the first and second transmissive reflective surfaces, the incident angle on the image sensor is not sufficiently relaxed. In a case where the value of inequality (3) becomes higher than the upper limit of inequality (3), the incident angle on the image sensor can be easily relaxed; however, the incident angle is excessively corrected toward the optical axis by reflection at the first and second transmissive reflective surfaces, so that light travels too far in a direction from the outside toward the optical axis (a direction where an object position is located at a super-infinity distance).

Inequality (4) defines a change in ray angle between incidence on the first transmissive reflective surface and emission from the first transmissive reflective surface, and represents refractive power provided by passage through the first transmissive reflective surface. Angles θ1 and θ2 will be described in detail below. FIG. 39 is an explanatory diagram of the outermost off-axis ray passing through the center of the aperture stop. P is an outermost off-axis ray traveling toward a maximum image height of the image sensor and passing through the center of the aperture stop SP. The angle θ1 is an angle relative to the optical axis just before the ray P enters the first transmissive reflective surface, and the angle θ2 is an angle relative to the optical axis after the ray P passes through the first transmissive reflective surface, is reflected by the second transmissive reflective surface, and is reflected by the first transmissive reflective surface. In a case where the value of inequality (4) becomes lower than the lower limit of inequality (4), a change in angle at the first transmissive reflective surface becomes small, the effects of providing the first and second transmissive reflective surfaces are reduced, negative refractive power within the entire imaging optical system becomes strong, and coma flare in the sagittal direction increases. In a case where the value of inequality (4) becomes higher than the upper limit of inequality (4), an incident angle on the image sensor relative to the optical axis becomes directed from the outside toward the optical axis, and a ray is shielded or fall outside an effective area of a light receiving sensor of the image sensor before reaching the light receiving sensor.

Inequality (5) defines a focal length of a structure surrounded by the first transmissive reflective surface and the second transmissive reflective surface, and corresponds to refractive power of the second transmissive reflective surface. In a case where the value of inequality (5) becomes lower than the lower limit of inequality (5), a curvature of the second transmissive reflective surface becomes small, an incident angle on the image sensor increases in a direction from outside toward the optical axis, and a ray is shielded or fall outside an effective area of a light receiving sensor of the image sensor before reaching the light receiving sensor. In a case where the value of inequality (5) becomes higher than the upper limit of inequality (5), a curvature of the second transmissive reflective surface becomes large, and an incident angle on the image sensor relative to the optical axis becomes large.

Inequality (6) indicates that a region between the first transmissive reflective surface and the second transmissive reflective surface is filled with a refractive index medium other than air. In a case where no refractive index medium is present and the region is composed only of air, a relative positional relationship between the first transmissive reflective surface and the second transmissive reflective surface may cause changes in an incident angle on the image sensor and optical performance degradation such as one-sided defocusing. By employing a configuration that can be integrally processed, such as a lens, accuracy of the relative positional relationship can be ensured. In a case where the value of inequality (6) becomes lower than the lower limit of inequality (6), processing using a glass material is unavailable, the relative positional relationship between the first transmissive reflective surface and the second transmissive reflective surface easily deviates, and optical performance such as one-sided defocusing is affected. In a case where the value of inequality (6) becomes higher than the upper limit of inequality (6), no glass material is present and an air gap is formed, so that a configuration using reflective surfaces is used and is constrained by a mechanical structure, whereby the relative positional relationship between the first transmissive reflective surface and the second transmissive reflective surface easily deviates, and optical performance such as one-sided defocusing is affected.

In a case where the value of inequality (7) becomes lower than the lower limit of inequality (7), the overall lens length becomes excessively large. In addition, the entire lens system separates from the image sensor, and an incident angle of light entering the image sensor relative to the optical axis becomes excessively steep. Furthermore, a width of a light beam passing through front and rear surfaces adjacent to the first transmissive reflective surface increases, so that an amount of aberration generated when the light beam passes through the surfaces increases. In a case where the value of inequality (7) is higher than the upper limit of inequality (7), the incident angle on the image sensor can be easily accommodated, but the second transmissive reflective surface interferes with the image sensor.

Inequality (8) defines the refractive power of a negative lens disposed near the image plane for correcting curvature of field. A configuration is made in which the curvature of field is corrected by a strong refractive power of the negative lens, reflection in a region surrounded between the first transmissive reflective surface and the second transmissive reflective surface relaxes an incident angle on the image sensor, and the negative lens mainly corrects the curvature of field. In a case where the value of inequality (8) becomes lower than the lower limit of inequality (8) and the refractive power of the negative lens becomes weak, correction of field curvature becomes insufficient. As a result, it becomes necessary to compensate for the insufficient negative refractive power by a lens system disposed closer to the object than the negative lens, and coma flare in the sagittal direction increases significantly. In a case where the value of inequality (8) becomes higher than the upper limit of inequality (8) and the refractive power of the negative lens becomes excessively strong, correction of field curvature becomes easier; however, field curvature correction becomes excessive, and an incident angle on the image sensor relative to the optical axis increases.

Inequality (9) defines the refractive power of the negative lens near the image plane of the entire lens system to correct curvature of field. In a case where the refractive power of the negative lens is weak below the lower limit of inequality (9), the field curvature correction will be insufficient, and the insufficient negative refractive power is borne by the lens system closer to the object than the negative lens. This results in significant coma flare in the sagittal direction. In a case where the refractive power of the negative lens is strong above the upper limit of inequality (9), this will be beneficial in correcting curvature of field, but the field curvature correction will be excessive and an incident angle on the image sensor relative to the optical axis increases.

Inequality (10) defines the shape factor of the structure surrounded by the object-side surface of the negative lens disposed adjacent to and closer to the object than the first transmissive reflective surface and the second transmissive reflective surface. More specifically, inequality (10) specifies that the object-side surface of the negative lens has a strong concave curvature to correct curvature of field, and that the second transmissive reflective surface is convex from a planar surface toward the image side to relax the incident angle. In a case where the value of inequality (10) becomes lower than the lower limit of inequality (10), the second transmissive reflective surface will be concave toward the image side. In a case where the second transmissive reflective surface is concave toward the image side, rays originating from the image sensor will likely be reflected by the second transmissive reflective surface and return to the image sensor, which can lead to ghosting. In a case where the value of inequality (10) becomes higher than the upper limit of inequality (10), the curvature of the object-side surface of the negative lens disposed adjacent to and closer to the object than the first transmissive reflective surface will be weak, and the field of curvature becomes difficult.

Inequality (11) defines the refractive power of the region from the object-side lens surface of the negative lens disposed adjacent to and closer to the object than the first transmissive reflective surface to the second transmissive reflective surface, relative to the entire lens system, and defines the correction of curvature of field. In a case where the refractive power of the negative lens is weak below the lower limit of inequality (11), the correction of curvature of field will be insufficient, and the insufficient negative refractive power must be borne by the lens closer to the object than the negative lens. This results in significant coma flare in the sagittal direction. In a case where the refractive power of the negative lens is strong above the upper limit of inequality (11), it will be beneficial in correcting curvature of field, but will result in overcorrection of curvature of field.

Inequality (12) defines the refractive index between the first transmissive reflective surface and the second transmissive reflective surface and the refractive index of the negative lens disposed adjacent to and closer to the object than the first transmissive reflective surface; the higher the refractive index of the negative lens is, the longer the optical path length of the off-axis ray is, which is beneficial in correcting curvature of field. In a case where the refractive index of the negative lens increases below the lower limit of inequality (12), the curvature of field will be overcorrected. In a case where the refractive index of the negative lens reduces above the upper limit of inequality (12), the amount of curvature of field correction will be insufficient, and either the curvature of the object-side surface of the negative lens will become tighter to compensate for the shortfall, or the insufficient negative refractive power will be borne by a lens closer to the object than the negative lens. As a result, significant coma flare in the sagittal direction will occur.

Inequality (13) defines the distance on the optical axis from the object-side lens surface of the negative lens disposed adjacent to and closer to the object than the first transmissive reflective surface to the second transmissive reflective surface relative to the optical overall length. In a case where the value of inequality (13) becomes lower than the lower limit of inequality (13), the negative lens becomes too thin and cannot be processed. In a case where the value of inequality (13) becomes higher than the upper limit of inequality (13), the overall lens length increases. Furthermore, the width of the light beam passing through each surface increases. In particular, since the object-side lens surface of the negative lens has a strong curvature and is disposed on the object side, the width of the light beam passing through the negative lens increases, which increases a change range in the surface shape of the negative lens relative to the light beam, increasing the aberration.

Inequality (14) defines the focal length of the entire lens system and the position of the first transmissive reflective surface, and also the position within the entire lens system at which reflection is relaxed for the incident angle of the off-axis ray on the image sensor. In a case where the value of inequality (14) becomes lower than the lower limit of inequality (14), the distance from the first transmissive reflective surface to the image plane increases, and the overall lens length becomes too long. Furthermore, the entire lens system separates from the image sensor, but the incident angle on the image sensor will be steeper. In a case where the value of inequality (14) becomes higher than the upper limit of inequality (14), it will be easier to adjust the incident angle on the image sensor, but the final surface of the entire lens system will interfere with the image sensor.

Inequality (15) is an inequality between the outer diameter of the lens disposed closest to the object and the outer diameter of the lens disposed closest to the image plane, and is an inequality that defines the miniaturization. The outer diameter is set to 2 mm plus the effective diameter. In a case where the value of inequality (15) becomes lower than the lower limit of inequality (15), the outer diameter of the lens disposed closest to the object will be too small, the specified Fno light beam cannot enter the lens system, and it becomes difficult to achieve a large aperture scheme. In a case where the value of inequality (15) becomes higher than the upper limit of inequality (15), the outer diameter of the lens disposed closest to the object will be too large, and the weight of the lens increases.

In the imaging optical system according to each example, light amount loss occurs due to the first and second transmissive reflective surfaces, so if the F-number is large, the amount of light reaching the image sensor becomes very small. Therefore, the imaging optical system according to each example may satisfy inequality (16).

The numerical ranges of inequalities (3) to (16) may be set to the following numerical ranges of inequalities (3a) to (16a):

$$0.38 \leq LD / L \leq 0.82 \qquad ( 3 a )$$

$$1.3 \leq θ 1 / θ 2 \leq 16. \qquad ( 4 a )$$

$$2.2 \leq fP / f \leq 12. \qquad ( 5 a )$$

$$1.47 \leq nd \leq 2.2 \qquad ( 6 a )$$

$$2. \leq L / Li \leq 185. \qquad ( 7 a )$$

$$- 0.8 \leq fN / f \leq - 0.12 \qquad ( 8 a )$$

$$- 7. \leq fN / f \leq - 0.34 \qquad ( 9 a )$$

$$- 1. \leq ( R 1 - R 2 ) / ( R 1 + R 2 ) \leq 0.2 \qquad ( 10 a )$$

$$- 25. \leq fF / f \leq - 0.4 \qquad ( 11 a )$$

$$0.7 \leq nd / ndN \leq 1.05 \qquad ( 12 a )$$

$$0.01 \leq d / L \leq 0.12 \qquad ( 13 a )$$

$$0.01 \leq Lh / f \leq 0.85 \qquad ( 14 a )$$

$$0.4 \leq Oe / Ie \leq 3. \qquad ( 15 a )$$

$$0.6 \leq Fno \leq 4. \qquad ( 16 a )$$

The numerical ranges of inequalities (3) to (16) may be set to the numerical ranges of the following inequalities (3b) to (16b):

$$0.4 \leq LD / L \leq 0.8 \qquad ( 3 b )$$

$$1.4 \leq θ 1 / θ 2 \leq 13. \qquad ( 4 b )$$

$$2.4 \leq fP / f \leq 13. \qquad ( 5 b )$$

$$1.49 \leq nd \leq 2.1 \qquad ( 6 b )$$

$$2.5 \leq L / Li \leq 170. \qquad ( 7 b )$$

$$- 0.75 \leq fN / fP \leq - 0.15 \qquad ( 8 b )$$

$$- 6. \leq fN / f \leq - 0.38 \qquad ( 9 b )$$

$$- 1. \leq ( R 1 - R 2 ) / ( R 1 + R 2 ) \leq 0.15 \qquad ( 10 b )$$

$$- 6. \leq fF / f \leq - 0.45 \qquad ( 11 b )$$

$$0.75 \leq nd / ndN \leq 1.02 \qquad ( 12 b )$$

$$0.01 \leq d / L \leq 0.09 \qquad ( 13 b )$$

$$0.01 \leq Lh / f \leq 0.8 \qquad ( 14 b )$$

$$0.5 \leq Oe / Ie \leq 2. \qquad ( 15 b )$$

$$0.7 \leq Fno \leq 2.5 \qquad ( 16 b )$$

In the imaging optical system according to each example, for example, applying the following configuration can reduce ghost light (unnecessary light leakage) from an optical path that passes through without being reflected by any transmissive reflective surface, while suppressing a light amount reduction of a normal imaging optical path.

### Polarization-Based Configuration 1

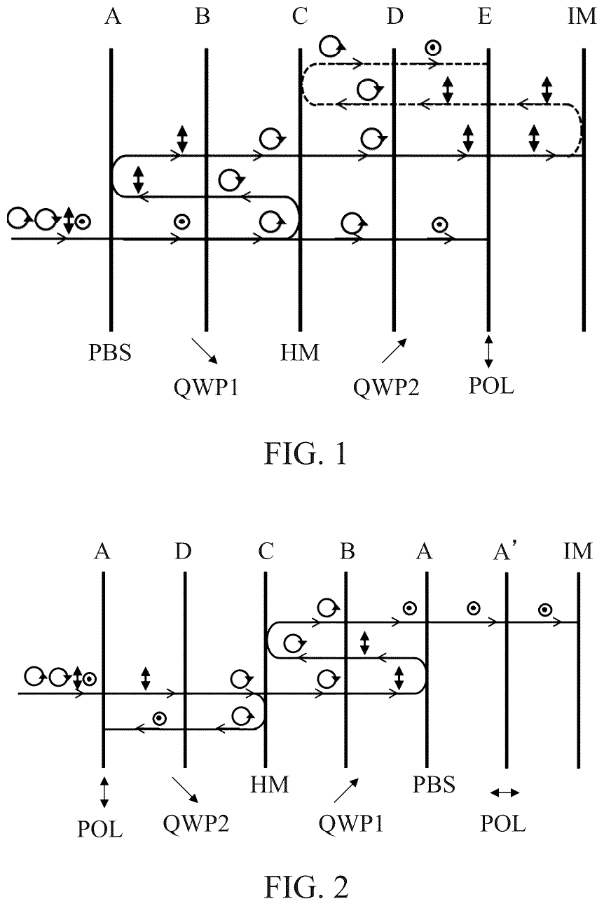

With reference to FIG. 1, a configuration utilizing polarization will be described. The imaging optical system according to this configuration includes two transmissive reflective surfaces. A transmissive reflective surface disposed closer to the object than the imaging optical system according to this configuration is implemented by a polarization-selective transmissive reflective element (PBS): A. A transmissive reflective surface disposed closer to the image plane than the imaging optical system according to this configuration is implemented by a half-mirror (HM): C. A first quarter waveplate (QWP1): B is disposed between the polarization-selective transmissive reflective element PBS and the half-mirror HM. Further, a second quarter waveplate (QWP2): D and a linear polarizer (POL): E are disposed between the half-mirror HM and an image plane IM arranged in this order from the object side toward the image side.

The polarization-selective transmissive reflective element A is configured to reflect linearly polarized light polarized in the same direction as that of light transmitted through the linear polarizer E, and to transmit linearly polarized light polarized in a direction orthogonal to it. The polarization-selective transmissive reflective element A may include, for example, a wire-grid polarizer or a reflective polarizer having a phase-difference film laminated structure. In this case, a wire-grid forming surface or a phase-difference film surface of the polarization-selective transmissive reflective element A functions as a transmissive reflective surface. The wire-grid polarizer is not limited to one in which metal wires are aligned, and may be any element having thin metal or dielectric layers arranged at predetermined intervals and functioning as a polarization-selective transmissive reflective element. For example, an element formed by aligning metal or dielectric layers by vapor deposition can be used.

The first quarter waveplate B and the second quarter waveplate D are arranged such that their slow axes are tilted by 45° relative to a polarization transmission axis of the linear polarizer E. The first quarter waveplate B and the second quarter waveplate D may be arranged such that their respective slow axes are tilted by 90° relative to each other. Due to this arrangement, wavelength dispersion characteristics of the wave plates can be canceled when light passes through the first quarter waveplate B and the second quarter waveplate D.

The half-mirror C may be, for example, a half-mirror formed by a dielectric multilayer film or metal deposition, and a mirror surface of the half-mirror C functions as a transmissive reflective surface. The linear polarizer E may be, for example, an absorption-type linear polarizer.

Next, optical path selection and operation in the polarization utilizing configuration will be described.

Light incident on the imaging optical system from the object side is converted into linearly polarized light by the polarization-selective transmissive reflective element A, converted into circularly polarized light by the first quarter waveplate B, and then introduced into the half-mirror C. Apart of the light reaching the half-mirror C is reflected, becomes reversely rotating circularly polarized light, and returns to the first quarter waveplate B.

The reversely rotating circularly polarized light returning to the first quarter waveplate B is converted by the first quarter waveplate B into linearly polarized light polarized in a direction orthogonal to that when the light initially passed through the polarization-selective transmissive reflective element A, and returns to the polarization-selective transmissive reflective element A. The light returning to the polarization-selective transmissive reflective element A is reflected by the polarization-selective transmissive reflective element A. Due to polarization selectivity of the polarization-selective transmissive reflective element A, linearly polarized light polarized in a direction orthogonal to that when initially transmitted through the polarization-selective transmissive reflective element A is reflected.

On the other hand, a part of the light reaching the half-mirror C transmits it, is converted by the second quarter waveplate D into linearly polarized light polarized in the same direction as that when initially transmitted through the polarization-selective transmissive reflective element A, and then is incident on the linear polarizer E, where the light is absorbed.

The light reflected by the polarization-selective transmissive reflective element A is converted into circularly polarized light by the first quarter waveplate B and then incident on the half-mirror C. A part of the light reaching the half-mirror C transmits it and then enters the second quarter waveplate D. The light incident on the second quarter waveplate D is converted into linearly polarized light oriented parallel to the linearly polarized light reflected by the polarization-selective transmissive reflective element A. The light that has transmitted through the second quarter waveplate D enters the linear polarizer E. Since the polarization of the light coincides with a transmission axis of the linear polarizer E, most of the light transmits it and is guided to the image plane IM.

Due to the above operation, only light that passes through the polarization beam splitter PBS, is reflected by the half-mirror C, is reflected by the polarization-selective transmissive reflective element PBS, and transmits through the half-mirror C is guided to the image plane IM.

In a case where a cholesteric liquid crystal is used instead of the half-mirror C, the cholesteric liquid crystal may be disposed so as to significantly reflect circularly polarized light in the same rotating direction as that of incident light during the first reflection of the cholesteric liquid crystal. Due to this configuration, it is possible to increase light amount in a normal optical path while reducing ghost light.

Solid-state image sensors or Charge Coupled Devices (CCDs) usable as the image plane IM generally have high surface reflectance. In this configuration, light reflected by the image plane IM transmits again through the linear polarizer E and is converted into circularly polarized light by the second quarter waveplate D. The light exiting the second quarter waveplate D is reflected by the half-mirror C, becomes reversely rotating circularly polarized light, and passes again through the second quarter waveplate D. The circularly polarized light is converted by the second quarter waveplate D into linearly polarized light polarized in a direction orthogonal to that just after passing through the linear polarizer E. Since this polarization direction is orthogonal to the transmission axis of the linear polarizer E, most of the light is absorbed by the linear polarizer E. Thus, in this configuration, light reflected sequentially by the image plane IM and the half-mirror C is almost cut, thereby reducing visibility of ghosts and flare associated with the image plane IM. In order to obtain such a reflection reducing effect, an optical low-pass filter utilizing birefringence may not exist between the image plane IM and the linear polarizer E, because the optical low-pass filter may cause deviation from a desired polarization state.

In this configuration, a quarter waveplate may be disposed between the polarization-selective transmissive reflective element A and the object. In this case, the quarter waveplate is disposed such that a fast axis or a slow axis thereof forms an angle of 45° with a transmission axis of the polarization-selective transmissive reflective element A. Due to this arrangement, even when light incident from the object side is linearly polarized, imaging can be performed regardless of a polarization direction. Alternatively, a depolarizer may be disposed instead of the quarter waveplate. The depolarizer can use, for example, “Cosmoshine SRF” manufactured by Toyobo Co., Ltd.

### Polarization Utilizing Configuration 2

With reference to FIG. 2, another configuration utilizing polarization will be described. The imaging optical system according to this configuration includes two transmissive reflective surfaces. Here, a transmissive reflective surface disposed closer to the object than the imaging optical system includes a half-mirror (HM): C, and a transmissive reflective surface disposed closer to the image plane than the imaging optical system includes by a polarization-selective transmissive reflective element (PBS): A. A first quarter waveplate (QWP1): B is disposed between the polarization-selective transmissive reflective element PBS and the half-mirror HM. Further, a linear polarizer (POL): E and a second quarter waveplate (QWP2): D are arranged in this order from the object side toward the image side between the half-mirror HM and the object plane.

The configuration of each polarization element and the arrangement of the optical axis orientation are the same as those in polarization utilizing configuration 1.

Next, an optical path selection and operation in a polarization utilizing configuration will be described.

Light incident on the imaging optical system from the object side is converted into linearly polarized light by the linear polarizer E, is converted into circularly polarized light by the second quarter waveplate D, and then enters a half-mirror C. A part of the light reaching the half-mirror C is reflected to become reversely rotating circularly polarized light, and returns to the second quarter waveplate D.

The light reflected by the half-mirror C becomes circularly polarized light rotating in a direction opposite to that at incidence. This light is converted by the second quarter waveplate D into linearly polarized light whose polarization direction is orthogonal to that of the light passing through the linear polarizer E, and then enters the linear polarizer E, where it is absorbed.

On the other hand, the light that has transmitted through the half-mirror C is converted by the first quarter waveplate B into linearly polarized light polarized in the same direction as that just after transmission through the linear polarizer E. This linearly polarized light is reflected by the polarization-selective transmissive reflective element A and returns to the first quarter waveplate B. Thereafter, the light is converted into circularly polarized light by the first quarter waveplate B, and a part of it is reflected by the half-mirror C. The light reflected by the half-mirror C again enters the first quarter waveplate B, and is converted into linearly polarized light whose polarization direction is orthogonal to that at the time of reflection by the polarization-selective transmissive reflective element A. This linearly polarized light transmits through the polarization-selective transmissive reflective element A and is guided to an image plane IM.

By the above operation, only light that has transmitted through the half-mirror C, been reflected by the polarization-selective transmissive reflective element PBS, been reflected by the half-mirror C, and transmitted through the polarization-selective transmissive reflective element PBS is guided to the image plane IM.

In this arrangement, a linear polarizer A′ may be disposed between the polarization-selective transmissive reflective element A and the image plane IM. In this case, the transmission axis of the linear polarizer A′ is aligned with the transmission axis of the polarization-selective transmissive reflective element A. Due to this configuration, light reflected by the image plane IM, reflected by the polarization-selective transmissive reflective element A, and then incident again on the image plane IM to generate ghost or flare may be absorbed.

In this configuration, a quarter waveplate may be disposed between the linear polarizer E and the object. In this case, the quarter waveplate is disposed such that an angle between a fast axis or a slow axis of the quarter waveplate and the transmission axis of the linear polarizer E is 45°. Due to this arrangement, even when light incident from the object side is linearly polarized light, imaging can be performed regardless of a polarization direction thereof. Alternatively, a depolarizing element may be disposed instead of the quarter waveplate. The depolarizing element can use, for example, “COSMOSHINE SRF” manufactured by Toyobo Co., Ltd.

While the above description of the configuration uses terms such as orthogonal, parallel, and 45°, these terms may not be strictly 90°, 0°, and 45°, respectively. These angles may be within ±5°, within +2°, or within +1° of desired angles.

The imaging optical system according to the example may use polymer materials or glass materials as a lens material. However, lenses disposed between the first transmissive reflective surface and the second transmissive reflective surface may have low birefringence.

Hereinafter, the configuration of the imaging optical system according to each example will be described.

### Example 1

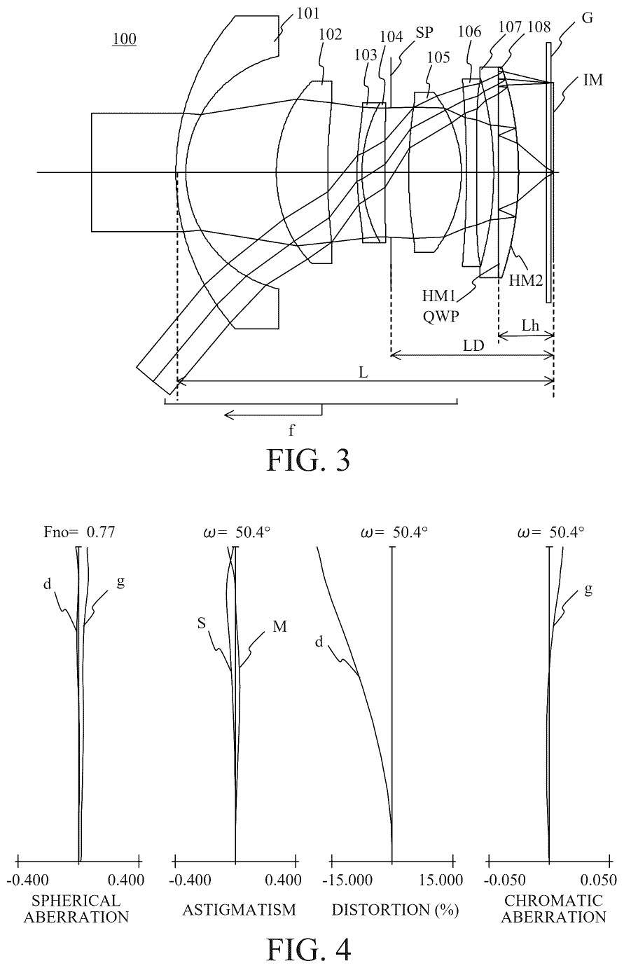

FIG. 3 is a cross-sectional view of an imaging optical system 100 according to this example. The imaging optical system 100 includes, in order from an object side to an image side, a first negative lens 101, a second positive lens 102, a cemented lens that includes a third negative lens 103 and a fourth positive lens 104, an aperture stop SP, a fifth positive lens 105, and a sixth negative lens 106. The first negative lens 101, the second positive lens 102, the third negative lens 103, the fourth positive lens 104, and the fifth positive lens 105 constitute a focusing unit f. Focusing is performed by moving these lenses integrally in an optical axis direction. The imaging optical system 100 further includes, in order from the object side to the image side, a cemented lens that includes a seventh lens 107 including a first transmissive reflective surface HM1 and an eighth lens 108 including a second transmissive reflective surface HM2, and a sensor protection glass G. The seventh lens 107 includes a quarter waveplate QWP closer to the image plane than the first transmissive reflective surface HM1.

FIG. 4 is an aberration diagram of the imaging optical system 100 in an in-focus state at infinity. In a spherical aberration diagram, Fno represents an F-number, and spherical aberration amounts for the d-line (wavelength 587.6 nm) and the g-line (wavelength 435.8 nm) are illustrated. In an astigmatism diagram, S represents an astigmatism amount on a sagittal image plane, and M represents an astigmatism amount on a meridional image plane. A distortion diagram illustrates a distortion amount for the d-line. A chromatic aberration diagram illustrates a chromatic aberration amount for the g-line. ω represents a half angle of view (degrees).

### Example 2

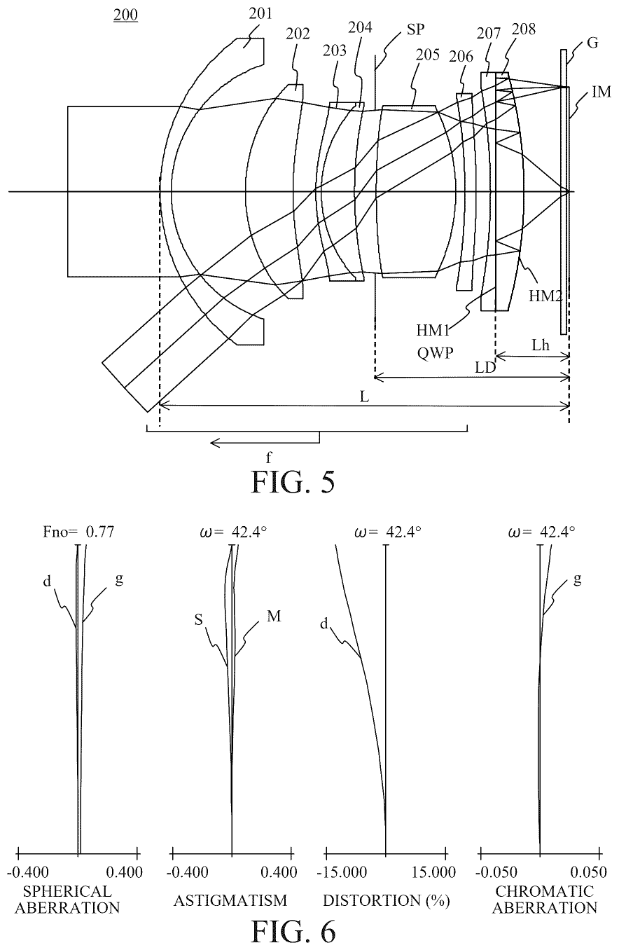

FIG. 5 is a cross-sectional view of an imaging optical system 200 according to this example. The imaging optical system 200 includes, in order from an object side to an image side, a first negative lens 201, a second positive lens 202, a cemented lens that includes a third negative lens 203 and a fourth positive lens 204, an aperture stop SP, a fifth positive lens 205, and a sixth negative lens 206. The first negative lens 201, the second positive lens 202, the third negative lens 203, the fourth positive lens 204, the fifth positive lens 205, and the sixth negative lens 206 constitute a focusing unit f Focusing is performed by moving these lenses integrally in an optical axis direction. The imaging optical system 200 further includes, in order from the object side to the image side, a cemented lens that includes a seventh lens 207 including a first transmissive reflective surface HM1 and an eighth lens 208 including a second transmissive reflective surface HM2, and a sensor protection glass G. The seventh lens 207 includes a quarter waveplate QWP closer to the image plane than the first transmissive reflective surface HM1.

FIG. 6 is an aberration diagram of the imaging optical system 200 in an in-focus state at infinity. In a spherical aberration diagram, Fno represents an F-number, and spherical aberration amounts for the d-line (wavelength 587.6 nm) and the g-line (wavelength 435.8 nm) are illustrated. In an astigmatism diagram, S represents an astigmatism amount on a sagittal image plane, and M represents an astigmatism amount on a meridional image plane. A distortion diagram illustrates a distortion amount for the d-line. A chromatic aberration diagram illustrates a chromatic aberration amount for the g-line. ω represents a half angle of view (degrees).

### Example 3

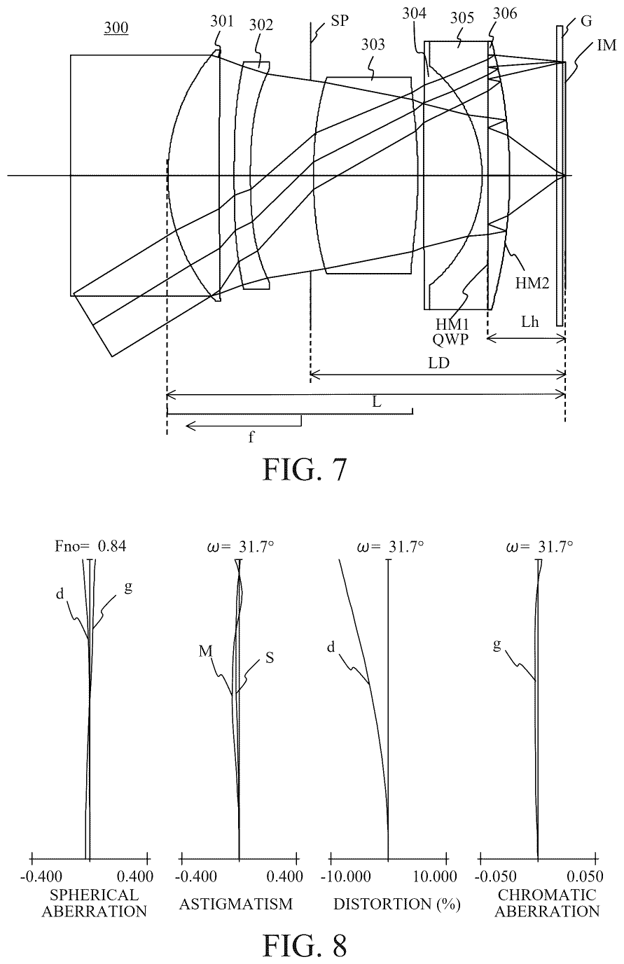

FIG. 7 is a cross-sectional view of an imaging optical system 300 according to this example. The imaging optical system 300 includes, in order from an object side to an image side, a first positive lens 301, a second negative lens 302, an aperture stop SP, and a third positive lens 303. The first positive lens 301, the second negative lens 302, and the third positive lens 303 constitute a focusing unit f. Focusing is performed by moving these lenses integrally in an optical axis direction. The imaging optical system 300 further includes, in order from the object side to the image side, a cemented lens that includes a fourth positive lens 204, a fifth negative lens 305 including a first transmissive reflective surface HM1, and a sixth positive lens 308 including a second transmissive reflective surface HM2, and a sensor protection glass G. The fifth negative lens 305 includes a quarter waveplate QWP closer to the image plane than the first transmissive reflective surface HM1.

FIG. 8 is an aberration diagram of the imaging optical system 300 in an in-focus state at infinity. In a spherical aberration diagram, Fno represents an F-number, and spherical aberration amounts for the d-line (wavelength 587.6 nm) and the g-line (wavelength 435.8 nm) are illustrated. In an astigmatism diagram, S represents an astigmatism amount on a sagittal image plane, and M represents an astigmatism amount on a meridional image plane. In a distortion diagram, a distortion amount for the d-line is illustrated. In a chromatic aberration diagram, a chromatic aberration amount for the g-line is illustrated. ω represents a half angle of view (degrees).

### Example 4

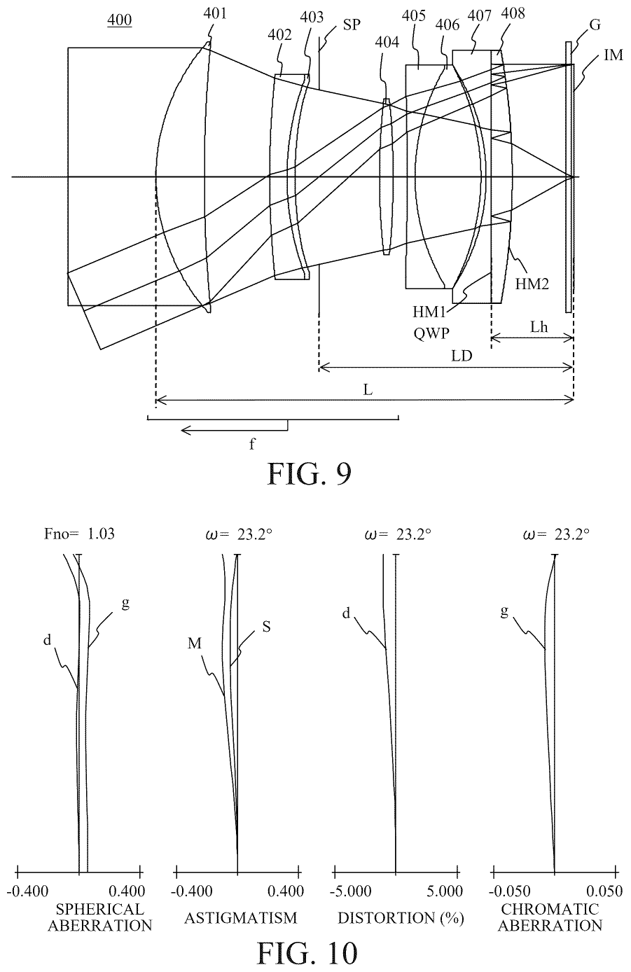

FIG. 9 is a cross-sectional view of an imaging optical system 400 according to this example. The imaging optical system 400 includes, in order from an object side to an image side, a first positive lens 401, a cemented lens that includes a second negative lens 402 and a third positive lens 403, an aperture stop SP, a fourth positive lens 404, and a cemented lens that includes a fifth negative lens 405 and a sixth positive lens 406. The first positive lens 401, the second negative lens 402, the third positive lens 403, and the fourth positive lens 404 constitute a focusing unit f. Focusing is performed by moving these lenses integrally in an optical axis direction. The imaging optical system 400 further includes, in order from the object side to the image side, a cemented lens that includes a seventh negative lens 407 including a first transmissive reflective surface HM1 and an eighth positive lens 408 including a second transmissive reflective surface HM2, and a sensor protection glass G. The seventh negative lens 407 includes a quarter waveplate QWP closer to the image plane than the first transmissive reflective surface HM1.

FIG. 10 is an aberration diagram of the imaging optical system 400 in an in-focus state at infinity. In a spherical aberration diagram, Fno represents an F-number, and spherical aberration amounts for the d-line (wavelength 587.6 nm) and the g-line (wavelength 435.8 nm) are illustrated. In an astigmatism diagram, S represents an astigmatism amount on a sagittal image plane, and M represents an astigmatism amount on a meridional image plane. In a distortion diagram, a distortion amount for the d-line is illustrated. In a chromatic aberration diagram, a chromatic aberration amount for the g-line is illustrated. ω represents a half angle of view (degrees).

### Example 5

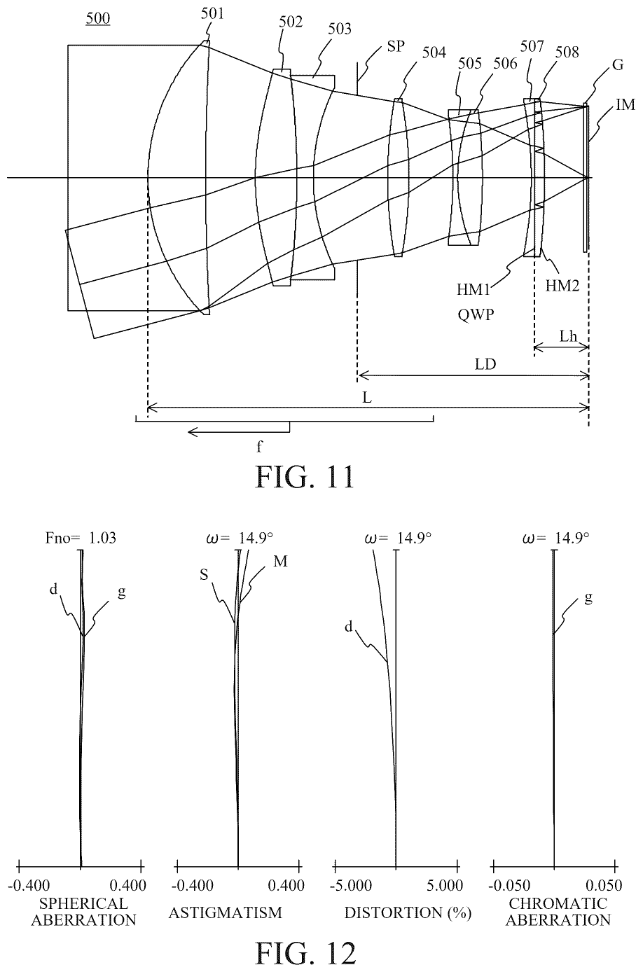

FIG. 11 is a cross-sectional view of an imaging optical system 500 according to this example. The imaging optical system 500 includes, in order from an object side to an image side, a first positive lens 501, a cemented lens that includes a second positive lens 502 and a third negative lens 503, an aperture stop SP, and a fourth positive lens 504. The first positive lens 501, the second positive lens 502, the third negative lens 503, and the fourth positive lens 504 constitute a focusing unit f. Focusing is performed by moving these lenses integrally in an optical axis direction. The imaging optical system 500 further includes a cemented lens that includes a fifth negative lens 505 and a sixth positive lens 506. The imaging optical system 500 further includes, in order from the object side to the image side, a cemented lens that includes a seventh negative lens 507 including a first transmissive reflective surface HM1 and an eighth positive lens 508 including a second transmissive reflective surface HM2, and a sensor protection glass G. The seventh negative lens 507 includes a quarter waveplate QWP closer to the image plane than the first transmissive reflective surface HM1.

FIG. 12 is an aberration diagram of the imaging optical system 500 in an in-focus state at infinity. In a spherical aberration diagram, Fno represents an F-number, and spherical aberration amounts for the d-line (wavelength 587.6 nm) and the g-line (wavelength 435.8 nm) are illustrated. In an astigmatism diagram, S represents an astigmatism amount on a sagittal image plane, and M represents an astigmatism amount on a meridional image plane. In a distortion diagram, a distortion amount for the d-line is illustrated. In a chromatic aberration diagram, a chromatic aberration amount for the g-line is illustrated. ω represents a half angle of view (degrees).

### Example 6

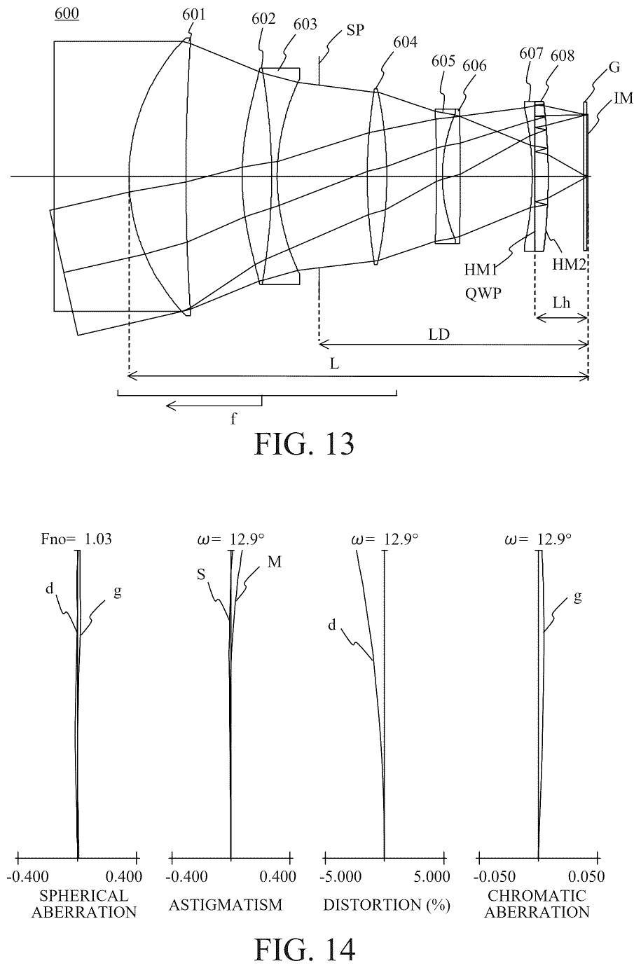

FIG. 13 is a cross-sectional view of an imaging optical system 600 of this example. The imaging optical system 600 includes, in order from an object side to an image side, a first positive lens 601, a cemented lens that includes a second positive lens 602 and a third negative lens 603, an aperture stop SP, and a fourth positive lens 604. The first positive lens 601, the second positive lens 602, the third negative lens 603, and the fourth positive lens 604 constitute a focusing unit f. Focusing is performed by moving these lenses integrally in an optical axis direction. The imaging optical system 600 further includes a cemented lens that includes a fifth negative lens 605 and a sixth positive lens 606. The imaging optical system 600 further includes a cemented lens that includes a seventh negative lens 607 including a first transmissive reflective surface HM1 and an eighth positive lens 608 including a second transmissive reflective surface HM2, and a sensor protection glass G. The seventh negative lens 607 includes a quarter wave plate QWP closer to the image plane than the first transmissive reflective surface HM1.

FIG. 14 is an aberration diagram of the imaging optical system 600 in an in-focus state at infinity. In a spherical aberration diagram, Fno represents an F-number, and spherical aberration amounts for the d-line (wavelength 587.6 nm) and the g-line (wavelength 435.8 nm) are illustrated. In an astigmatism diagram, S represents an astigmatism amount on a sagittal image plane, and M represents an astigmatism amount on a meridional image plane. In a distortion diagram, a distortion amount for the d-line is illustrated. In a chromatic aberration diagram, a chromatic aberration amount for the g-line is illustrated. ω represents a half angle of view (degrees).

### Example 7

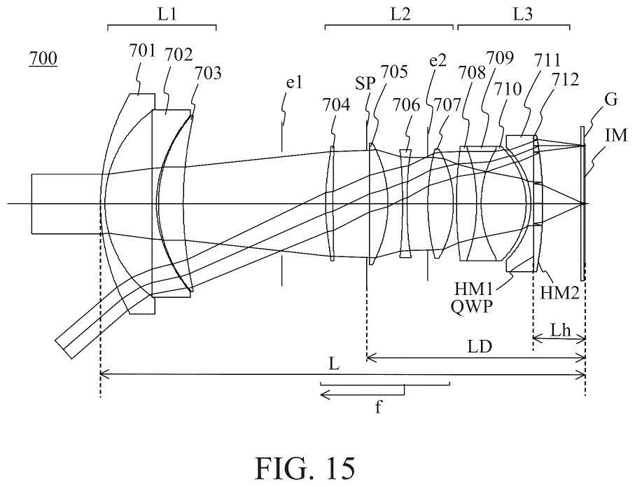

FIG. 15 is a cross-sectional view of an imaging optical system 700 at a wide-angle end according to this example. The imaging optical system 700 includes, in order from an object side to an image side, a first negative lens 701, a second negative lens 702, a third positive lens 703, and a flare cut-off stop e1. The imaging optical system 700 further includes, in order from the object side to the image side, a fourth positive lens 704, an aperture stop SP, a fifth positive lens 705, a sixth negative lens 706, a flare cut-off stop e2, and a seventh positive lens 707. The fourth positive lens 704, the fifth positive lens 705, the sixth negative lens 706, and the seventh positive lens 707 constitute a focusing unit f. Focusing is performed by moving these lenses integrally in an optical axis direction. The imaging optical system 700 further includes a cemented lens that includes an eighth positive lens 708, a ninth negative lens 709, and a tenth positive lens 710. The imaging optical system 700 further includes, in order from the object side to the image side, a cemented lens that includes an eleventh negative lens 711 including a first transmissive reflective surface HM1 and a twelfth positive lens 712 including a second transmissive reflective surface HM2, and a sensor protection glass G. The eleventh negative lens 711 includes a quarter wave plate QWP closer to the image plane than the first transmissive reflective surface HM1.

The imaging optical system 700 includes, as lens units that move integrally during zooming, a first lens unit L1 having a negative refractive power, a second lens unit L2 having a positive refractive power, and a third lens unit L3 having a positive refractive power. The first lens unit L1 includes the first negative lens 701, the second negative lens 702, and the third positive lens 703. The second lens unit L2 includes the fourth positive lens 704, the fifth positive lens 705, the sixth negative lens 706, and the seventh positive lens 707. The third lens unit L3 includes the eighth positive lens 708, the ninth negative lens 709, the tenth positive lens 710, the eleventh negative lens 711, and the twelfth positive lens 712.

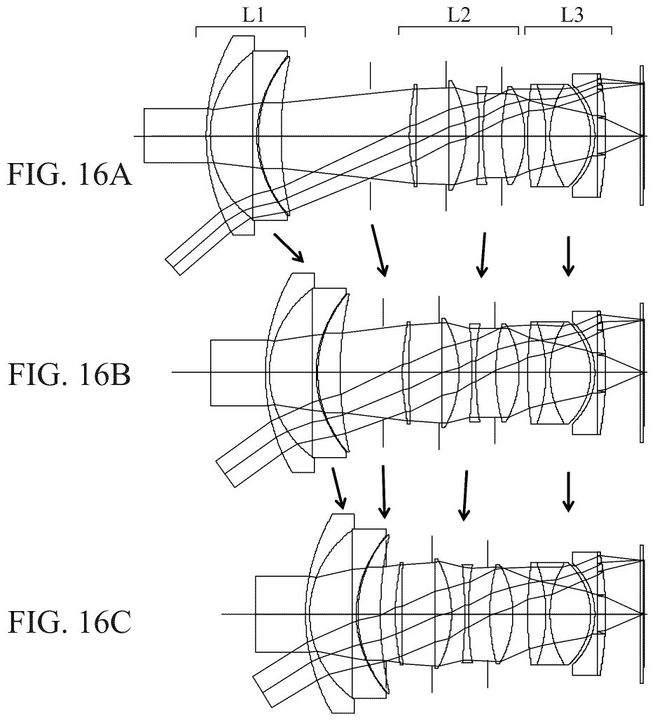

FIGS. 16A, 16B, and 16C are diagrams illustrating cross-sectional views and moving loci of the imaging optical system 700 from the wide-angle end to a telephoto end in an in-focus state at infinity. A cross-sectional view (in FIG. 16A) illustrates the wide-angle end, a cross-sectional view (in FIG. 16B) illustrates an intermediate zoom position, and a cross-sectional view (in FIG. 16C) illustrates the telephoto end. The first lens unit L1 moves toward the image side, the flare cut-off stop e1 moves toward the image side, the second lens unit L2 moves toward the object side, and the third lens unit L3 is fixed.

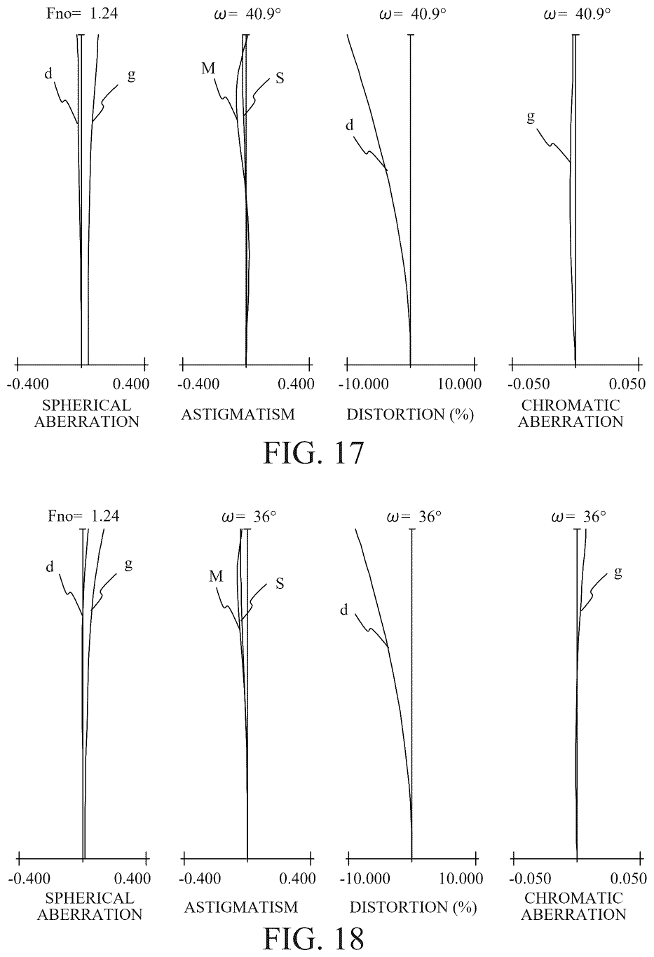

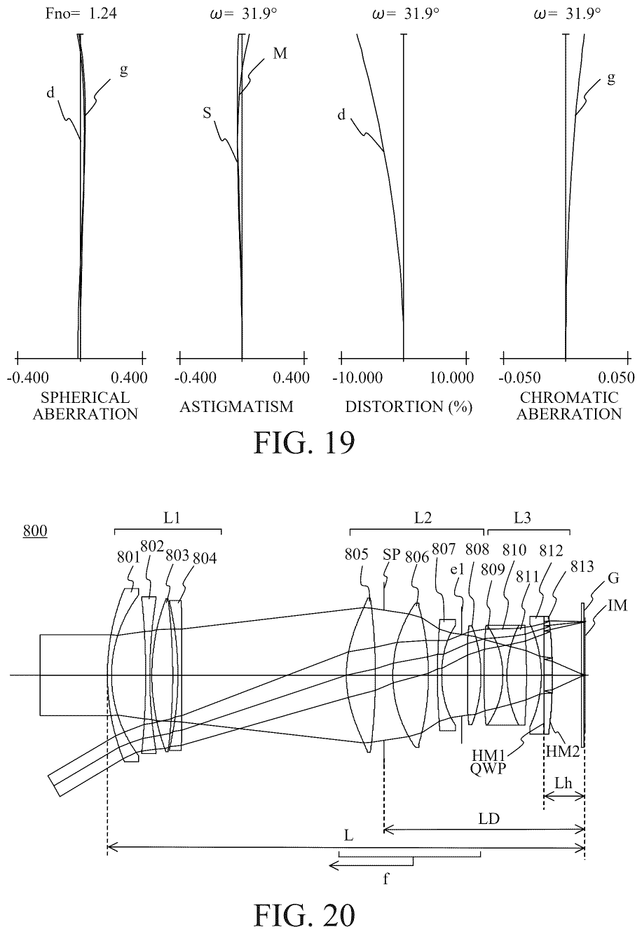

FIGS. 17, 18, and 19 are aberration diagrams of the imaging optical system 700 in an in-focus state at infinity at the wide-angle end, the intermediate zoom position, and the telephoto end, respectively. In a spherical aberration diagram, Fno represents an F-number, and spherical aberration amounts for the d-line (wavelength 587.6 nm) and the g-line (wavelength 435.8 nm) are illustrated. In an astigmatism diagram, S represents an astigmatism amount on a sagittal image plane, and M represents an astigmatism amount on a meridional image plane. In a distortion diagram, a distortion amount for the d-line is illustrated. In a chromatic aberration diagram, a chromatic aberration amount for the g-line is illustrated. ω represents a half angle of view (degrees).

### Example 8

FIG. 20 is a cross-sectional view of an imaging optical system 800 at a wide-angle end according to this example. The imaging optical system 800 includes, in order from an object side to an image side, a first negative lens 801, a second negative lens 802, a third positive lens 803, and a fourth negative lens 804. The imaging optical system 800 further includes, in order from the object side to the image side, a fifth positive lens 805, an aperture stop SP, a sixth positive lens 806, a seventh negative lens 807, a flare cut-off stop e1, and an eighth positive lens 808. The fifth positive lens 805, the sixth positive lens 806, the seventh negative lens 807, and the eighth positive lens 808 constitute a focusing unit f. Focusing is performed by moving these lenses integrally in an optical axis direction. The imaging optical system 800 further includes a cemented lens that includes a ninth positive lens 809, a tenth negative lens 810, and an eleventh positive lens 811. The imaging optical system 800 further includes, in order from the object side to the image side, a cemented lens that includes a twelfth negative lens 812 including a first transmissive reflective surface HM1 and a thirteenth positive lens 813 including a second transmissive reflective surface HM2, and a sensor protection glass G. The twelfth negative lens 812 includes a quarter wave plate QWP closer to the image plane than the first transmissive reflective surface HM1.

The imaging optical system 800 includes, as lens units that move integrally during zooming, a first lens unit L1 having a negative refractive power, a second lens unit L2 having a positive refractive power, and a third lens unit L3 having a positive refractive power. The first lens unit L1 includes the first negative lens 801, the second negative lens 802, the third positive lens 803, and the fourth negative lens 804. The second lens unit L2 includes the fifth positive lens 805, the sixth positive lens 806, the seventh negative lens 807, and the eighth positive lens 808. The third lens unit L3 includes the ninth positive lens 809, the tenth negative lens 810, the eleventh positive lens 811, the twelfth negative lens 812, and the thirteenth positive lens 813.

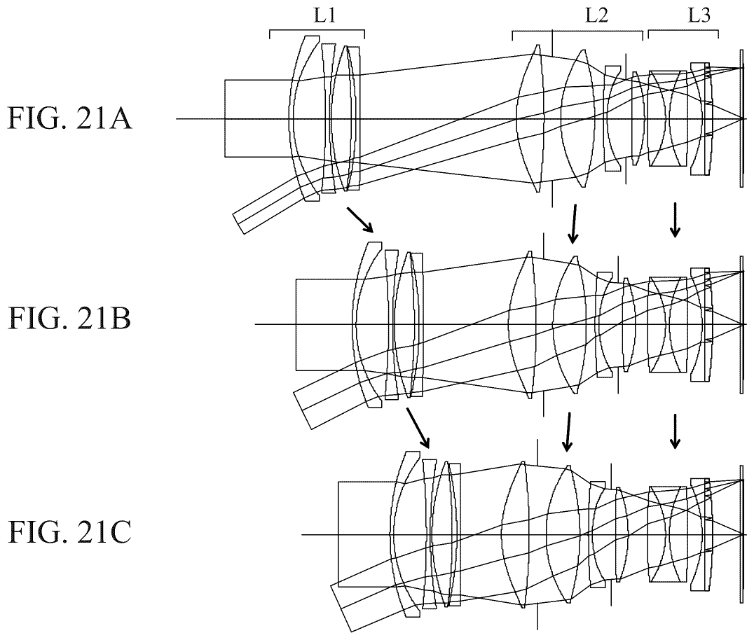

FIGS. 21A, 21B, and 21C are diagrams illustrating cross-sectional views and moving loci of the imaging optical system 800 from the wide-angle end to a telephoto end in an in-focus state at infinity. A cross-sectional view (in FIG. 21A) illustrates the wide-angle end, a cross-sectional view (in FIG. 21B) illustrates an intermediate zoom position, and a cross-sectional view (in FIG. 21C) illustrates the telephoto end. The first lens unit L1 moves toward the image side, the second lens unit L2 moves toward the object side, and the third lens unit L3 is fixed.

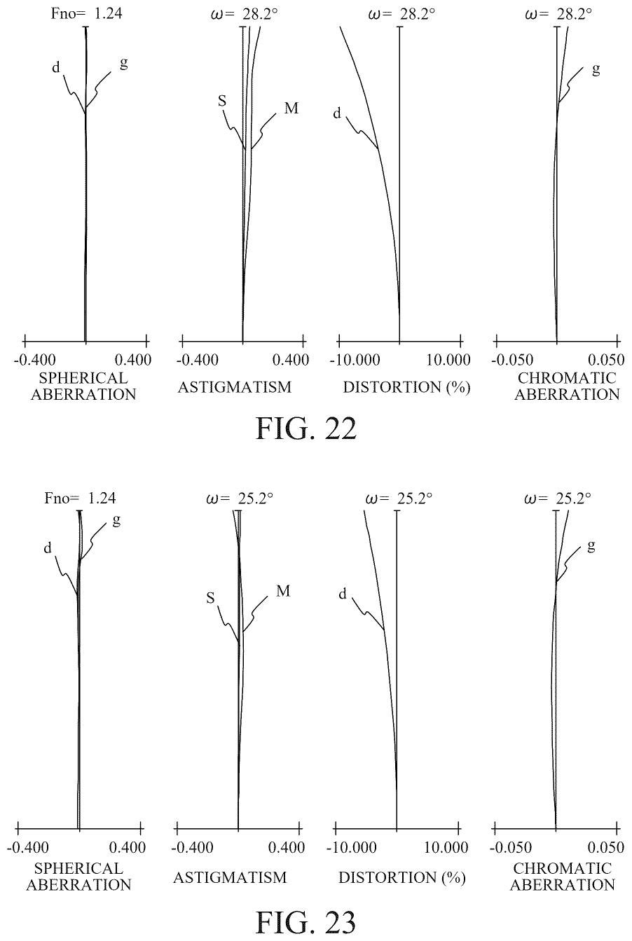

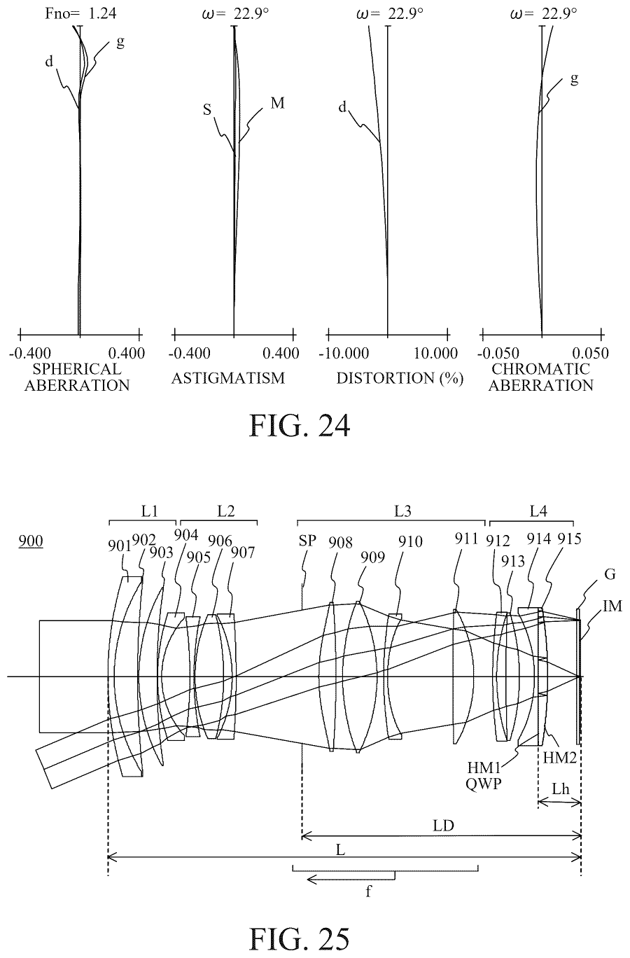

FIGS. 22, 23, and 24 are aberration diagrams of the imaging optical system 800 in an in-focus state at infinity at the wide-angle end, the intermediate zoom position, and the telephoto end, respectively. In a spherical aberration diagram, Fno represents an F-number, and spherical aberration amounts for the d-line (wavelength 587.6 nm) and the g-line (wavelength 435.8 nm) are illustrated. In an astigmatism diagram, S represents an astigmatism amount on a sagittal image plane, and M represents an astigmatism amount on a meridional image plane. In a distortion diagram, a distortion amount for the d-line is illustrated. In a chromatic aberration diagram, a chromatic aberration amount for the g-line is illustrated. ω represents a half angle of view (degrees).

### Example 9

FIG. 25 is a cross-sectional view of an imaging optical system 900 at a wide-angle end according to this example. The imaging optical system 900 includes, in order from an object side to an image side, a first negative lens 901, a second positive lens 902, and a third positive lens 903. The imaging optical system 900 further includes, in order from the object side to the image side, a fourth negative lens 904, a fifth positive lens 905, a sixth positive lens 906, and a seventh negative lens 907. The imaging optical system 900 further includes, in order from the object side to the image side, an aperture stop SP, an eighth positive lens 908, a ninth positive lens 909, a tenth negative lens 910, and an eleventh positive lens 911. The eighth positive lens 908, the ninth positive lens 909, the tenth negative lens 910, and the eleventh positive lens 911 constitute a focusing unit f. Focusing is performed by moving these lenses integrally in an optical axis direction. The imaging optical system 900 further includes, in order from the object side to the image side, a twelfth negative lens 912 and a thirteenth positive lens 913. The imaging optical system 900 further includes, in order from the object side to the image side, a cemented lens that includes a fourteenth negative lens 914 including a first transmissive reflective surface HM1 and a fifteenth positive lens 915 including a second transmissive reflective surface HM2, and a sensor protection glass G. The fourteenth negative lens 914 includes a quarter wave plate QWP closer to the image plane than the first transmissive reflective surface HM1.

The imaging optical system 900 includes, as lens units that move integrally during zooming, a first lens unit L1 having a positive refractive power, a second lens unit L2 having a negative refractive power, a third lens unit L3 having a positive refractive power, and a fourth lens unit L4 having a positive refractive power. The first lens unit L1 includes the first negative lens 901, the second positive lens 902, and the third positive lens 903. The second lens unit L2 includes the fourth negative lens 904, the fifth positive lens 905, the sixth positive lens 906, and the seventh negative lens 907. The third lens unit L3 includes the eighth positive lens 908, the ninth positive lens 909, the tenth negative lens 910, and the eleventh positive lens 911. The fourth lens unit L4 includes the twelfth negative lens 912, the thirteenth positive lens 913, the fourteenth negative lens 914, and the fifteenth positive lens 915.

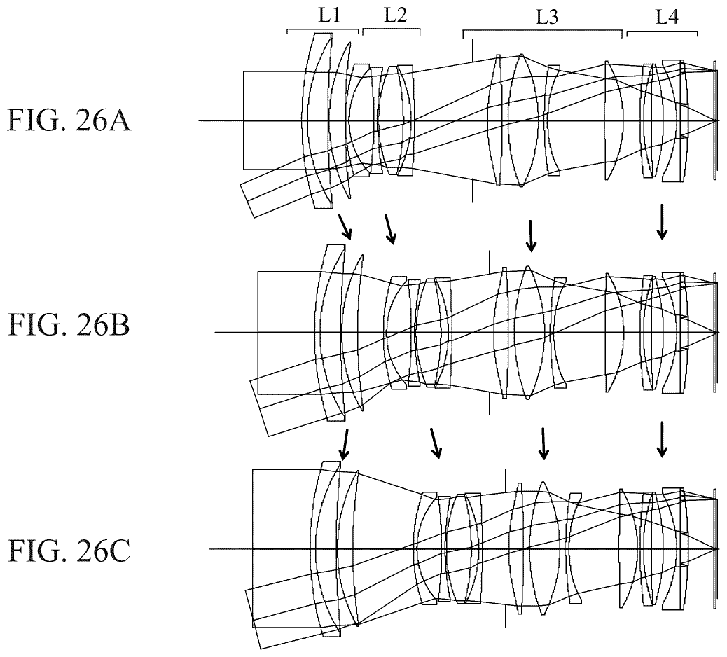

FIGS. 26A, 26B, and 26C are diagrams illustrating cross-sectional views and moving loci of the imaging optical system 900 from the wide-angle end to a telephoto end in an in-focus state at infinity. A cross-sectional view (in FIG. 26A) illustrates the wide-angle end, a cross-sectional view (in FIG. 26B) illustrates an intermediate zoom position, and a cross-sectional view (in FIG. 26C) illustrates the telephoto end. The first lens unit L1 moves once toward the image side and then moves toward the object side, the second lens unit L2 moves toward the image side, the third lens unit L3 moves toward the image side, and the fourth lens unit L4 is fixed.

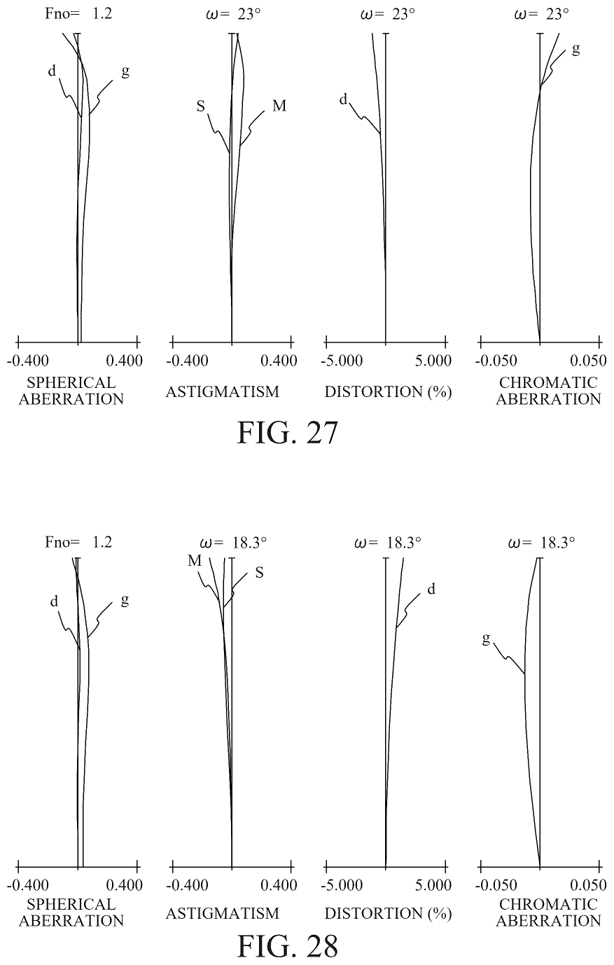

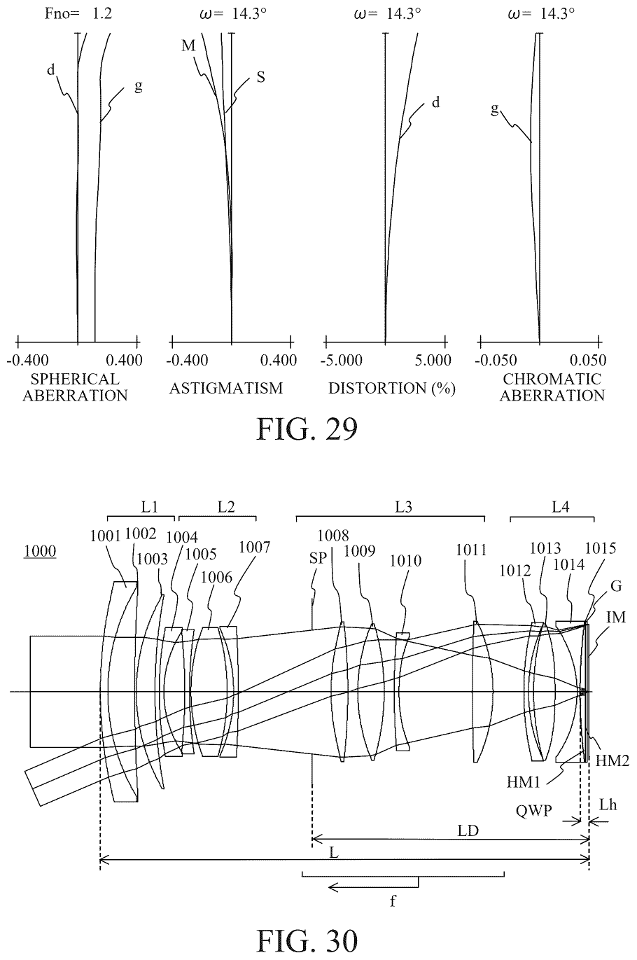

FIGS. 27, 28, and 29 are aberration diagrams of the imaging optical system 900 in an in-focus state at infinity at the wide-angle end, the intermediate zoom position, and the telephoto end, respectively. In a spherical aberration diagram, Fno represents an F-number, and spherical aberration amounts for the d-line (wavelength 587.6 nm) and the g-line (wavelength 435.8 nm) are illustrated. In an astigmatism diagram, S represents an astigmatism amount on a sagittal image plane, and M represents an astigmatism amount on a meridional image plane. In a distortion diagram, a distortion amount for the d-line is illustrated. In a chromatic aberration diagram, a chromatic aberration amount for the g-line is illustrated. ω represents a half angle of view (degrees).

### Example 10

FIG. 30 is a cross-sectional view of an imaging optical system 1000 at a wide-angle end according to this example. The imaging optical system 1000 includes, in order from an object side to an image side, a first negative lens 1001, a second positive lens 1002, and a third positive lens 1003. The imaging optical system 1000 further includes, in order from the object side to the image side, a fourth negative lens 1004, a fifth negative lens 1005, a sixth positive lens 1006, and a seventh negative lens 1007. The imaging optical system 1000 further includes, in order from the object side to the image side, an aperture stop SP, an eighth positive lens 1008, a ninth positive lens 1009, a tenth negative lens 1010, and an eleventh positive lens 1011. The eighth positive lens 1008, the ninth positive lens 1009, the tenth negative lens 1010, and the eleventh positive lens 1011 constitute a focusing unit f. Focusing is performed by moving these lenses integrally in an optical axis direction. The imaging optical system 1000 further includes, in order from the object side to the image side, a twelfth negative lens 1012 and a thirteenth positive lens 1013. The imaging optical system 1000 further includes, in order from the object side to the image side, a cemented lens that includes a fourteenth negative lens 1014 including a first transmissive reflective surface HM1 and a fifteenth positive lens 1015 including a second transmissive reflective surface HM2, and a sensor protection glass G. The fourteenth negative lens 1014 includes a quarter wave plate QWP closer to the image plane than the first transmissive reflective surface HM1.

The imaging optical system 1000 includes, as lens units that move integrally during zooming, a first lens unit L1 having a positive refractive power, a second lens unit L2 having a negative refractive power, a third lens unit L3 having a positive refractive power, and a fourth lens unit L4 having a positive refractive power. The first lens unit L1 includes the first negative lens 1001, the second positive lens 1002, and the third positive lens 1003. The second lens unit L2 includes the fourth negative lens 1004, the fifth negative lens 1005, the sixth positive lens 1006, and the seventh negative lens 1007. The third lens unit L3 includes the eighth positive lens 1008, the ninth positive lens 1009, the tenth negative lens 1010, and the eleventh positive lens 1011. The fourth lens unit L4 includes the twelfth negative lens 1012, the thirteenth positive lens 1013, the fourteenth negative lens 1014, and the fifteenth positive lens 1015.

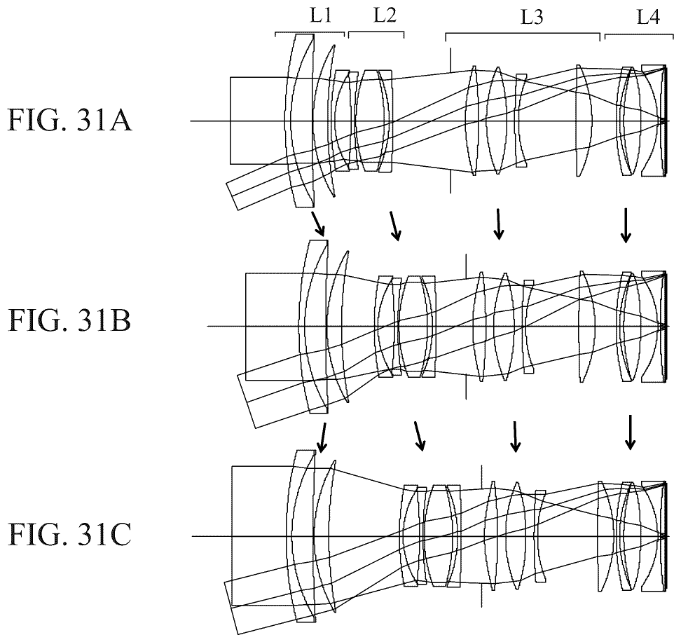

FIGS. 31A, 31B, and 31C are diagrams illustrating cross-sectional views and moving loci of the imaging optical system 1000 from the wide-angle end to a telephoto end in an in-focus state at infinity. A cross-sectional view (in FIG. 31A) illustrates the wide-angle end, a cross-sectional view (in FIG. 31B) illustrates an intermediate zoom position, and a cross-sectional view (in FIG. 31C) illustrates the telephoto end. The first lens unit L1 moves once toward the image side and then moves toward the object side, the second lens unit L2 moves toward the image side, the third lens unit L3 moves toward the image side, and the fourth lens unit L4 is fixed.

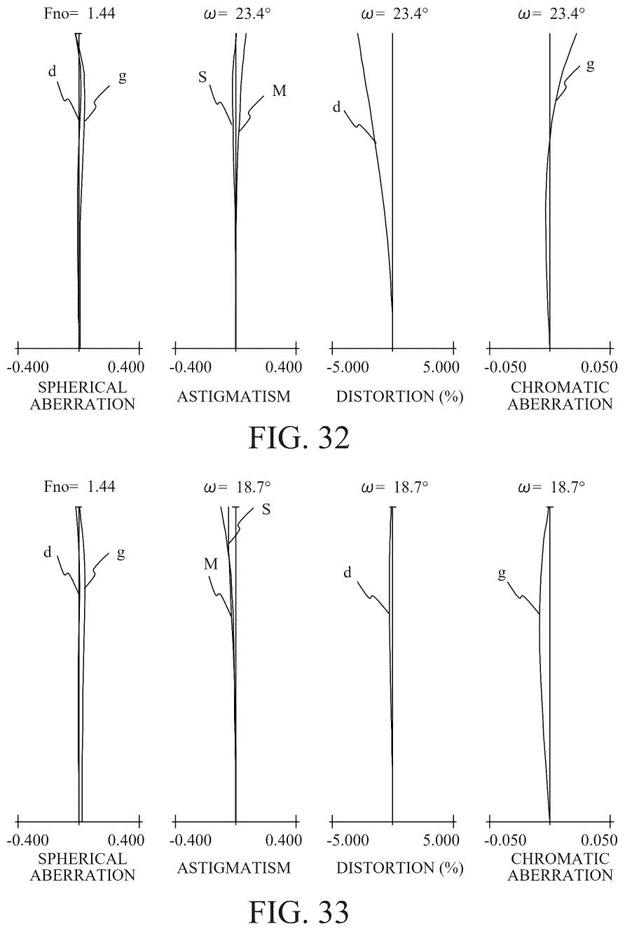

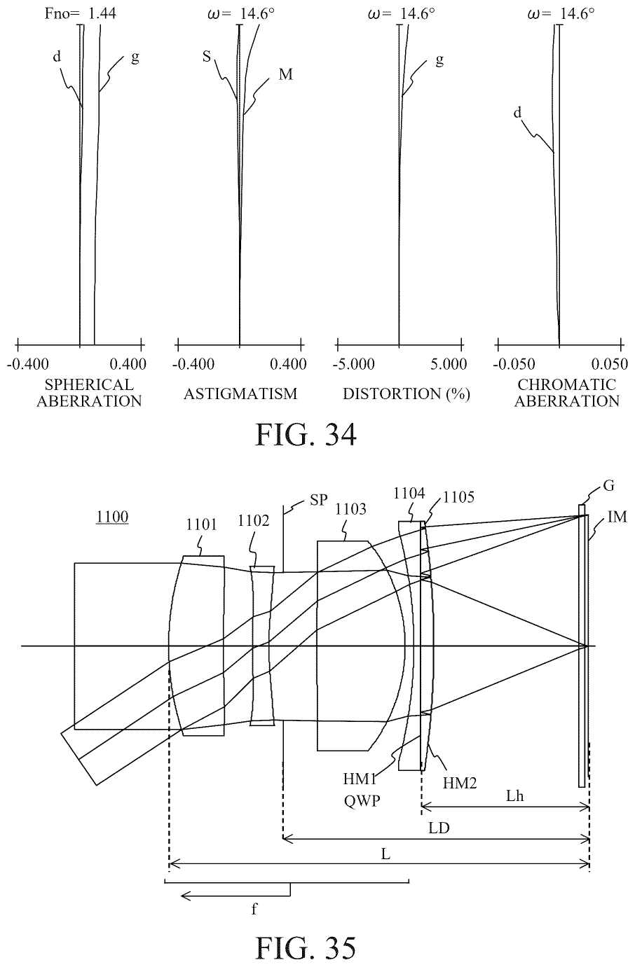

FIGS. 32, 33, and 34 are aberration diagrams of the imaging optical system 1000 in an in-focus state at infinity at the wide-angle end, the intermediate zoom position, and the telephoto end, respectively. In a spherical aberration diagram, Fno represents an F-number, and spherical aberration amounts for the d-line (wavelength 587.6 nm) and the g-line (wavelength 435.8 nm) are illustrated. In an astigmatism diagram, S represents an astigmatism amount on a sagittal image plane, and M represents an astigmatism amount on a meridional image plane. In a distortion diagram, a distortion amount for the d-line is illustrated. In a chromatic aberration diagram, a chromatic aberration amount for the g-line is illustrated. ω represents a half angle of view (degrees).

### Example 11

FIG. 35 is a sectional view of an imaging optical system 1100 according to the present example. The imaging optical system 1100 includes, in order from an object side to an image side, a first positive lens 1101, a second negative lens 1102, an aperture stop SP, and a third positive lens 1103. The first positive lens 1101, the second negative lens 1102, and the third positive lens 1103 constitute a focusing unit f. Focusing is performed by moving these lenses integrally in an optical axis direction. The imaging optical system 1100 further includes a cemented lens that includes a fourth negative lens 1104 having a first transmissive reflective surface HM1 and a fifth positive lens 1105 having a second transmissive reflective surface HM2, and a sensor protection glass G. The fourth negative lens 1104 includes a quarter waveplate QWP closer to the image plane than the first transmissive reflective surface HM1.

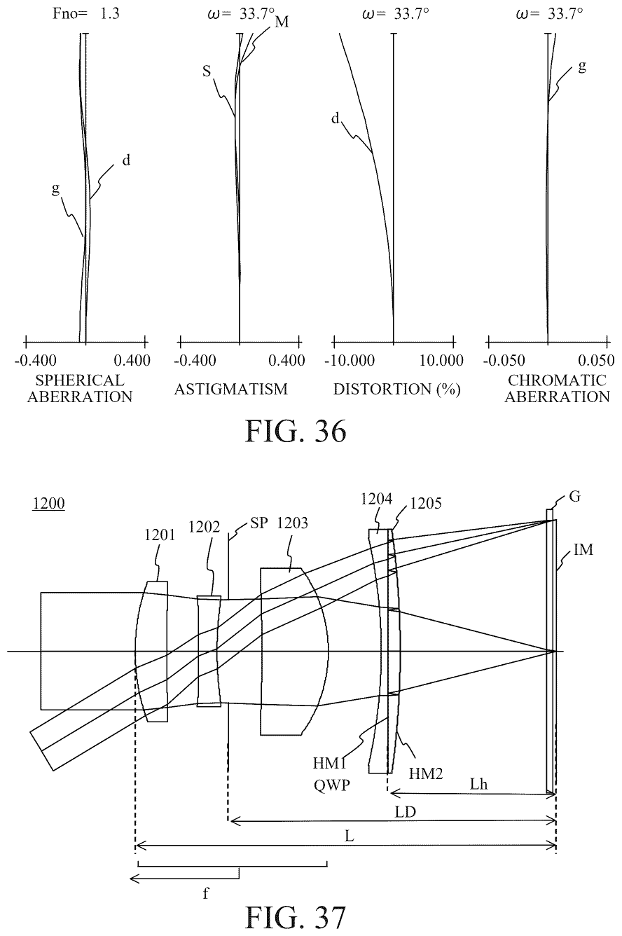

FIG. 36 is an aberration diagram of the imaging optical system 1100 in an in-focus state at infinity. In the spherical aberration diagram, Fno indicates an F-number, and spherical aberrations for the d-line (wavelength: 587.6 nm) and the g-line (wavelength: 435.8 nm) are illustrated. In the astigmatism diagram, S indicates an astigmatism amount on a sagittal image plane, and M indicates an astigmatism amount on a meridional image plane. In the distortion aberration diagram, a distortion amount for the d-line is illustrated. In the chromatic aberration diagram, a chromatic aberration amount for the g-line is illustrated. ω indicates a half angle of view (degrees).

### Example 12

FIG. 37 is a sectional view of an imaging optical system 1200 according to the present example. The imaging optical system 1200 includes, in order from an object side to an image side, a first positive lens 1201, a second negative lens 1202, an aperture stop SP, and a third positive lens 1203. The first positive lens 1201, the second negative lens 1202, and the third positive lens 1203 constitute a focusing unit f. Focusing is performed by moving these lenses integrally in an optical axis direction. The imaging optical system 1200 further includes a cemented lens that includes a fourth negative lens 1204 having a first transmissive reflective surface HM1 and a fifth positive lens 1205 having a second transmissive reflective surface HM2, and a sensor protection glass G. The fourth negative lens 1204 includes a quarter waveplate QWP closer to the image plane than the first transmissive reflective surface HM1.

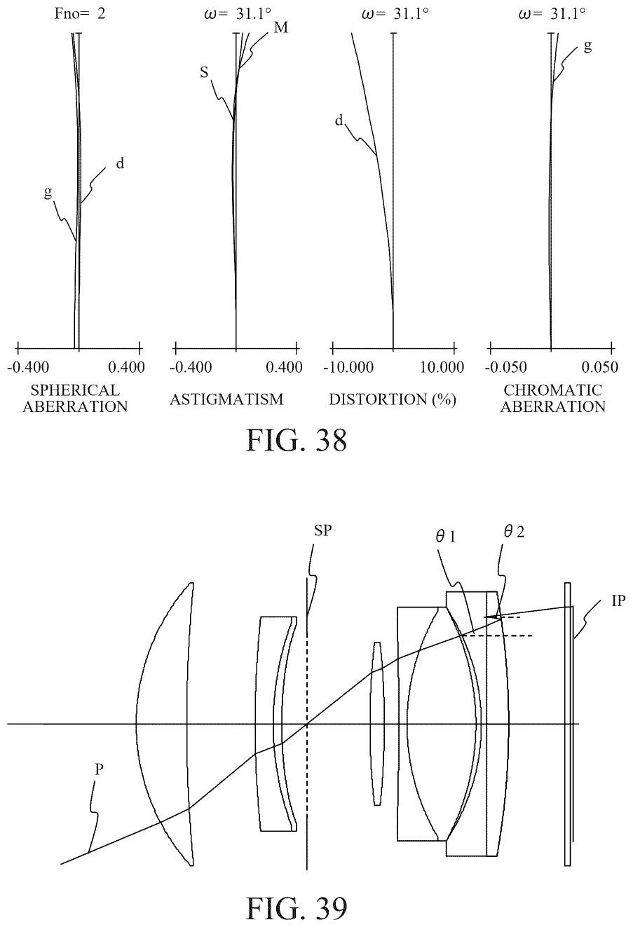

FIG. 38 is an aberration diagram of the imaging optical system 1200 in an in-focus state at infinity. In the spherical aberration diagram, Fno indicates an F-number, and spherical aberrations for the d-line (wavelength: 587.6 nm) and the g-line (wavelength: 435.8 nm) are illustrated. In the astigmatism diagram, S indicates an astigmatism amount on a sagittal image plane, and M indicates an astigmatism amount on a meridional image plane. In the distortion aberration diagram, a distortion amount for the d-line is illustrated. In the chromatic aberration diagram, a chromatic aberration amount for the g-line is illustrated. ω indicates a half angle of view (degrees).

Numerical examples corresponding to Examples 1 to 12 will be illustrated below. In surface data in each numerical example, r represents a radius of curvature of each optical surface, and d (mm) represents an on-axis distance (distance on the optical axis) between m-th and (m+1)-th surfaces, where m denotes a surface number counted from a light incident side. Further, nd represents a refractive index of each optical member for the d-line, and vd represents an Abbe number of the optical member. An Abbe number vd of a material is defined by the following equation:

$$vd = ( Nd - 1 ) / ( NF - NC )$$

where Nd, NF, and NC are refractive indices at d-line (587.6 nm), an F-line (486.1 nm), and a C-line (656.3 nm) in the Fraunhofer line, respectively.

In each numerical example, values of d, focal length (mm), F-number, and half angle of view (degrees) are values when the imaging optical system of each example is in an in-focus state on an object at infinity. “Back focus” represents a distance on the optical axis from a final lens surface (a lens surface closest to the image plane) to a paraxial image plane, expressed as an air-equivalent length. An “overall lens length” represents a length obtained by adding the back focus to a distance on the optical axis from a foremost lens surface (a lens surface closest to the object) of the imaging optical system to the final lens surface. A “lens unit” includes one or more lens units. WIDE, MIDDLE, and TELE means a wide-angle end, an intermediate zoom position, and a telephoto end, respectively.

In a case where an optical surface is an aspherical surface, an asterisk “*” is added to the right side of a surface number. An aspherical shape is defined by the following equation:

X=(h²/R)/[1+{1−(1+K)(h/R)²}^{1/2}]+A4×h⁴+A6×h⁶+A8×h⁸+A10×h¹⁰

where X is a displacement amount from a surface vertex in an optical axis direction, h is a height from the optical axis in a direction orthogonal to the optical axis, R is a paraxial radius of curvature, K is a conic constant, and A4, A6, A8, and A10 are aspherical coefficients of respective orders. In each aspherical coefficient, “e±XX” means “×10^{±XX}”.

Effective diameters are described for the first transmissive reflective surface and the second transmissive reflective surface. Although these transmissive reflective surfaces act on a light ray multiple times, a diameter having a maximum effective diameter among them is described.

NUMERICAL EXAMPLE 1
UNIT: mm
SURFACE DATA

| Surface No. | r | d | nd | νd | Effective Diameter |
|---|---|---|---|---|---|
| 1 | 47.127 | 2.00 | 1.53775 | 74.7 | 60.09 |
| 2 | 23.850 | 18.04 | | | 45.00 |
| 3* | 29.239 | 10.23 | 1.49710 | 81.6 | 34.61 |
| 4* | 114.591 | 5.82 | | | 27.78 |
| 5* | 51.788 | 1.00 | 1.88202 | 37.2 | 26.24 |
| 6 | 28.911 | 4.59 | 1.51742 | 52.4 | 25.77 |
| 7 | 741.525 | 1.13 | | | 25.82 |
| 8 (SP) | ∞ | 3.56 | | | 25.89 |
| 9* | 77.668 | 10.51 | 1.55332 | 71.7 | 26.19 |
| 10 | −26.066 | 1.02 | | | 30.49 |
| 11 | −226.514 | 2.07 | 1.83481 | 42.7 | 34.14 |
| 12* | −457.836 | 3.36 | | | 35.56 |
| 13 | −67.625 | 1.00 | 1.89286 | 20.4 | 36.05 |
| 14 | ∞ | 3.97 | 1.49700 | 81.5 | 39.28 |
| 15 | −67.674 | −3.97 | | | 40.41 |
| 16 | ∞ | 3.97 | | | 40.34 |
| 17 | −67.674 | 5.50 | | | 40.26 |
| 18 | ∞ | 1.00 | 1.51633 | 64.1 | 50.00 |
| 19 | ∞ | 0.50 | | | 50.00 |
| Image Plane | ∞ | | | | |

ASPHERIC DATA
3rd Surface
K = 0.00000e+00 A 4 = 2.68200e−06 A 6 = 4.08072e−09 A 8 = 2.50665e−11
4th Surface
K = 0.00000e+00 A 4 = −1.05832e−06 A 6 = −9.32302e−10 A 8 = −2.25900e−11
5th Surface
K = 0.00000e+00 A 4 = −1.11685e−05 A 6 = −1.56567e−08 A 8 = −1.66515e−10
9th Surface
K = 0.00000e+00 A 4 = −5.72921e−06 A 6 = 9.84264e−09
12th Surface
K = 0.00000e+00 A 4 = 8.38497e−06 A 6 = 2.02585e−10 A 8 = 5.15363e−12

VARIOUS DATA
ZOOM RATIO 1.00

| | |
|---|---|
| Focal Length | 18.19 |
| Fno | 0.77 |
| Half Angle of View (°) | 44.54 |
| Image Height | 17.90 |
| Overall Lens Length | 75.29 |
| BF (in air) | 6.65 |

SINGLE LENS DATA

| Lens | Starting Surface | Focal Length |
|---|---|---|
| 1 | 1 | −92.57 |
| 2 | 3 | 75.95 |
| 3 | 5 | −75.75 |
| 4 | 6 | 58.02 |
| 5 | 9 | 36.59 |
| 6 | 11 | −539.23 |
| 7 | 13 | −75.74 |
| 8 | 14 | 136.17 |
| 9 | 15 | 136.17 |
| 10 | 16 | 136.17 |
| 11 | 18 | 0.00 |

NUMERICAL EXAMPLE 2
UNIT: mm
SURFACE DATA

| Surface No. | r | d | nd | νd | Effective Diameter |
|---|---|---|---|---|---|
| 1 | 34.920 | 2.00 | 1.49700 | 81.5 | 53.56 |
| 2 | 24.436 | 13.52 | | | 44.93 |
| 3* | 29.483 | 8.67 | 1.49710 | 81.6 | 37.46 |
| 4* | 54.330 | 4.16 | | | 32.52 |
| 5* | 35.329 | 1.00 | 1.80400 | 46.6 | 30.82 |
| 6 | 23.085 | 6.05 | 1.49700 | 81.5 | 29.57 |
| 7 | 72.829 | 3.79 | | | 29.44 |
| 8 (SP) | ∞ | 0.17 | | | 29.70 |
| 9* | 126.462 | 14.50 | 1.60738 | 56.8 | 29.84 |
| 10 | −34.158 | 1.66 | | | 29.12 |
| 11 | −98.308 | 2.07 | 1.72916 | 54.7 | 32.60 |
| 12* | −114.637 | 2.58 | | | 34.43 |
| 13 | −106.158 | 1.00 | 1.95906 | 17.5 | 36.75 |
| 14 | ∞ | 5.10 | 1.49700 | 81.5 | 38.83 |
| 15 | −81.272 | −5.10 | | | 41.50 |
| 16 | ∞ | 5.10 | | | 41.46 |
| 17 | −81.272 | 6.70 | | | 41.42 |
| 18 | ∞ | 1.00 | 1.51633 | 64.1 | 50.00 |
| 19 | ∞ | 0.50 | | | 50.00 |
| Image Plane | ∞ | | | | |

ASPHERIC DATA
3rd Surface
K = 0.00000e+00 A 4 = 1.93351e−07 A 6 = 1.40310e−09 A 8 = 1.63609e−11
4th Surface
K = 0.00000e+00 A 4 = −1.40320e−05 A 6 = 1.57528e−08 A 8 = −1.95261e−11
5th Surface
K = 0.00000e+00 A 4 = −1.49134e−05 A 6 = −8.19704e−09 A 8 = −5.11549e−11
9th Surface
K = 0.00000e+00 A 4 = −1.86854e−07 A 6 = 1.61960e−08
12th Surface
K = 0.00000e+00 A 4 = 4.86104e−06 A 6 = 2.81753e−09 A 8 = 4.38490e−12

VARIOUS DATA
ZOOM RATIO 1.00

| | |
|---|---|
| Focal Length | 24.02 |
| Fno | 0.77 |
| Half Angle of View (°) | 38.52 |
| Image Height | 19.12 |
| Overall Lens Length | 74.46 |
| BF (in air) | 7.85 |

SINGLE LENS DATA

| Lens | Starting Surface | Focal Length |
|---|---|---|
| 1 | 1 | −174.85 |
| 2 | 3 | 116.22 |
| 3 | 5 | −85.97 |
| 4 | 6 | 65.36 |
| 5 | 9 | 45.84 |
| 6 | 11 | −1000.00 |
| 7 | 13 | −110.69 |
| 8 | 14 | 163.52 |
| 9 | 15 | 163.52 |
| 10 | 16 | 163.52 |
| 11 | 18 | 0.00 |

NUMERICAL EXAMPLE 3
UNIT: mm
SURFACE DATA

| Surface No. | r | d | nd | νd | Effective Diameter |
|---|---|---|---|---|---|
| 1 | 32.864 | 8.88 | 1.49700 | 81.5 | 41.70 |
| 2 | 1368.694 | 2.58 | | | 40.89 |
| 3* | 391.069 | 2.80 | 1.95375 | 32.3 | 37.87 |
| 4* | 107.203 | 10.39 | | | 35.40 |
| 5 (SP) | ∞ | 0.52 | | | 33.12 |
| 6* | 78.254 | 18.01 | 1.51633 | 64.1 | 32.35 |
| 7* | −89.131 | 1.00 | | | 28.91 |
| 8 | 940.768 | 10.10 | 1.57135 | 53.0 | 34.99 |
| 9 | −24.514 | 1.00 | 1.83481 | 42.7 | 36.27 |
| 10 | ∞ | 3.77 | 1.49700 | 81.5 | 43.92 |
| 11 | −87.122 | −3.77 | | | 44.84 |
| 12 | ∞ | 3.77 | | | 44.80 |
| 13 | −87.122 | 8.16 | | | 44.76 |
| 14 | ∞ | 1.00 | 1.51633 | 64.1 | 50.00 |
| 15 | ∞ | 0.50 | | | 50.00 |
| Image Plane | ∞ | | | | |

ASPHERIC DATA
3rd Surface
K = 0.00000e+00 A 4 = 1.30583e−05 A 6 = −1.65551e−08 A 8 = 5.12331e−12
4th Surface
K = 0.00000e+00 A 4 = 1.80379e−05 A 6 = −1.14415e−08
6th Surface
K = 0.00000e+00 A 4 = 3.41178e−06 A 6 = 4.14610e−09
7th Surface
K = 0.00000e+00 A 4 = 2.79360e−06 A 6 = 5.80781e−09

VARIOUS DATA

| | |
|---|---|
| ZOOM RATIO | 1.00 |
| Focal Length | 35.02 |
| Fno | 0.84 |
| Half Angle of View (°) | 29.40 |
| Image Height | 19.73 |
| Overall Lens Length | 68.71 |
| BF (in air) | 9.32 |

SINGLE LENS DATA

| Lens | Starting Surface | Focal Length |
|---|---|---|
| 1 | 1 | 67.60 |
| 2 | 3 | −155.60 |
| 3 | 6 | 83.77 |
| 4 | 8 | 41.98 |
| 5 | 9 | −29.37 |
| 6 | 10 | 175.30 |
| 7 | 11 | 175.30 |
| 8 | 12 | 175.30 |
| 9 | 14 | 0.00 |

NUMERICAL EXAMPLE 4
UNIT: mm
SURFACE DATA

| Surface No. | r | d | nd | νd | Effective Diameter |
|---|---|---|---|---|---|
| 1 | 38.891 | 9.25 | 1.61997 | 63.9 | 49.50 |
| 2 | 268.113 | 12.53 | | | 48.64 |
| 3 | 186.733 | 3.31 | 1.89286 | 20.4 | 37.86 |
| 4 | 53.469 | 1.56 | 1.85135 | 40.1 | 35.01 |
| 5* | 78.364 | 4.54 | | | 34.51 |
| 6 (SP) | ∞ | 11.62 | | | 33.53 |
| 7 | 137.484 | 2.63 | 1.60342 | 38.0 | 28.10 |
| 8 | −143.025 | 2.66 | | | 27.67 |
| 9 | −603.030 | 1.50 | 1.59282 | 68.6 | 36.70 |
| 10 | 41.251 | 12.62 | 1.58144 | 40.8 | 40.00 |
| 11 | −45.071 | 1.00 | | | 41.20 |
| 12 | −38.805 | 1.00 | 1.77830 | 23.9 | 41.21 |
| 13 | ∞ | 4.00 | 1.63980 | 34.5 | 45.59 |
| 14 | −136.851 | −4.00 | | | 46.95 |
| 15 | ∞ | 4.00 | | | 46.90 |
| 16 | −136.851 | 10.29 | | | 46.86 |
| 17 | ∞ | 1.00 | 1.51633 | 64.1 | 50.00 |
| 18 | ∞ | 0.50 | | | 50.00 |
| Image Plane | ∞ | | | | |

ASPHERIC DATA
5th Surface
K = 0.00000e+00 A 4 = 3.46583e−06 A 6 = 2.99436e−09

VARIOUS DATA

| | |
|---|---|
| ZOOM RATIO | 1.00 |
| Focal Length | 50.99 |
| Fno | 1.03 |
| Half Angle of View (°) | 22.99 |
| Image Height | 21.64 |
| Overall Lens Length | 80.00 |
| BF (in air) | 11.45 |

SINGLE LENS DATA

| Lens | Starting Surface | Focal Length |
|---|---|---|
| 1 | 1 | 72.26 |
| 2 | 3 | −84.91 |
| 3 | 4 | 192.15 |
| 4 | 7 | 116.58 |
| 5 | 9 | −65.07 |
| 6 | 10 | 39.15 |
| 7 | 12 | −49.86 |
| 8 | 13 | 213.90 |
| 9 | 14 | 213.90 |
| 10 | 15 | 213.90 |
| 11 | 17 | 0.00 |

NUMERICAL EXAMPLE 5
UNIT: mm
SURFACE DATA

| Surface No. | r | d | nd | νd | Effective Diameter |
|---|---|---|---|---|---|
| 1 | 59.672 | 17.42 | 1.49700 | 81.5 | 80.50 |
| 2 | 722.281 | 15.00 | | | 78.89 |
| 3* | 81.327 | 12.53 | 1.49700 | 81.5 | 63.44 |
| 4 | −249.811 | 4.99 | 1.70154 | 41.2 | 59.55 |
| 5 | 62.175 | 13.22 | | | 52.42 |
| 6 (SP) | ∞ | 9.18 | | | 49.98 |
| 7 | 134.805 | 6.40 | 1.49700 | 81.5 | 46.30 |
| 8 | −133.525 | 13.27 | | | 45.48 |
| 9 | −134.752 | 1.50 | 1.76182 | 26.5 | 35.73 |
| 10 | 53.339 | 7.49 | 1.95150 | 29.8 | 38.44 |
| 11* | −152.685 | 14.74 | | | 39.26 |
| 12 | −116.988 | 1.00 | 1.85025 | 30.1 | 44.31 |
| 13 | ∞ | 3.00 | 1.64769 | 33.8 | 45.48 |
| 14 | −207.078 | −3.00 | | | 46.20 |
| 15 | ∞ | 3.00 | | | 46.15 |
| 16 | −207.078 | 11.84 | | | 46.09 |
| 17 | ∞ | 1.00 | 1.51633 | 64.1 | 43.50 |
| 18 | ∞ | 0.50 | | | 43.37 |
| Image Plane | ∞ | | | | |

ASPHERIC DATA
3rd Surface
K = 0.00000e+00 A 4 = −9.17893e−07 A 6 = −3.55927e−10
11th Surface
K = 0.00000e+00 A 4 = 2.93531e−07 A 6 = 4.60080e−11

VARIOUS DATA

| | |
|---|---|
| ZOOM RATIO | 1.00 |
| Focal Length | 82.92 |
| Fno | 1.03 |
| Half Angle of View (°) | 14.62 |
| Image Height | 21.64 |
| Overall Lens Length | 133.09 |
| BF (in air) | 13.00 |

SINGLE LENS DATA

| Lens | Starting Surface | Focal Length |
|---|---|---|
| 1 | 1 | 129.74 |
| 2 | 3 | 125.02 |
| 3 | 4 | −70.50 |
| 4 | 7 | 136.05 |
| 5 | 9 | −49.99 |
| 6 | 10 | 42.29 |
| 7 | 12 | −137.59 |
| 8 | 13 | 319.72 |
| 9 | 14 | 319.72 |
| 10 | 15 | 319.72 |
| 11 | 17 | 0.00 |

NUMERICAL EXAMPLE 6
UNIT: mm
SURFACE DATA

| Surface No. | r | d | nd | νd | Effective Diameter |
|---|---|---|---|---|---|
| 1 | 69.284 | 19.84 | 1.49700 | 81.5 | 94.27 |
| 2 | 722.539 | 19.54 | | | 92.67 |
| 3* | 94.913 | 10.25 | 1.49700 | 81.5 | 73.24 |
| 4 | −217.337 | 2.00 | 1.74400 | 44.8 | 72.33 |
| 5 | 78.844 | 14.68 | | | 65.85 |
| 6 (SP) | ∞ | 16.68 | | | 63.93 |
| 7 | 190.708 | 6.77 | 1.49700 | 81.5 | 59.05 |
| 8 | −143.750 | 17.32 | | | 58.65 |
| 9 | −577.102 | 2.00 | 1.54072 | 47.2 | 45.40 |
| 10 | 55.848 | 6.29 | 1.71300 | 53.9 | 42.80 |
| 11* | −648.673 | 24.98 | | | 42.05 |
| 12 | −110.958 | 1.00 | 1.80518 | 25.4 | 47.98 |
| 13 | ∞ | 4.55 | 1.80610 | 33.3 | 49.22 |
| 14 | −218.870 | −4.55 | | | 50.28 |
| 15 | ∞ | 4.55 | | | 49.90 |
| 16 | −218.870 | 12.44 | | | 49.52 |
| 17 | ∞ | 1.00 | 1.51633 | 64.1 | 50.00 |
| 18 | ∞ | 0.50 | | | 50.00 |
| Image Plane | ∞ | | | | |

ASPHERIC DATA
3rd Surface
K = 0.00000e+00 A 4 = −5.70475e−07 A 6 = −1.67302e−10
11th Surface
K = 0.00000e+00 A 4 = 1.42663e−07 A 6 = 6.55028e−11

VARIOUS DATA

| | |
|---|---|
| ZOOM RATIO | 1.00 |
| Focal Length | 97.10 |
| Fno | 1.03 |
| Half Angle of View (°) | 12.56 |
| Image Height | 21.64 |
| Overall Lens Length | 159.85 |
| BF (in air) | 13.60 |

SINGLE LENS DATA

| Lens | Starting Surface | Focal Length |
|---|---|---|
| 1 | 1 | 152.65 |
| 2 | 3 | 134.39 |
| 3 | 4 | −77.54 |
| 4 | 7 | 166.04 |
| 5 | 9 | −94.07 |
| 6 | 10 | 72.39 |
| 7 | 12 | −137.81 |
| 8 | 13 | 271.52 |
| 9 | 14 | 271.52 |
| 10 | 15 | 271.52 |
| 11 | 17 | 0.00 |

NUMERICAL EXAMPLE 7
UNIT: mm
SURFACE DATA

| Surface No. | r | d | nd | νd | Effective Diameter |
|---|---|---|---|---|---|
| 1 | 74.855 | 1.50 | 2.00330 | 28.3 | 72.00 |
| 2 | 38.980 | 15.88 | | | 61.69 |
| 3 | 8731.995 | 1.50 | 1.49710 | 81.6 | 61.26 |
| 4* | 40.949 | 0.63 | | | 57.02 |
| 5 | 45.281 | 8.40 | 1.91650 | 31.6 | 57.10 |
| 6 | 131.225 | (Variable) | | | 56.27 |
| 7 | ∞ | (Variable) | | | 35.31 |
| 8* | 77.497 | 2.52 | 1.76802 | 49.2 | 36.89 |
| 9 | 636.111 | 11.25 | | | 36.96 |
| 10 (SP) | ∞ | 1.00 | | | 38.82 |
| 11 | −5038.428 | 6.26 | 1.58913 | 61.1 | 38.98 |
| 12 | −42.662 | 4.92 | | | 39.15 |
| 13 | −185.603 | 1.50 | 2.00330 | 28.3 | 34.96 |
| 14* | 184.694 | 7.00 | | | 34.49 |
| 15 | ∞ | (Variable) | | | 35.10 |
| 16* | 71.683 | 8.63 | 1.49710 | 81.6 | 35.42 |
| 17 | −36.820 | (Variable) | | | 35.24 |
| 18 | 142.633 | 6.83 | 1.84666 | 23.8 | 35.64 |
| 19 | −55.989 | 1.50 | 1.95375 | 32.3 | 35.51 |
| 20 | 36.259 | 15.19 | 1.43875 | 94.7 | 35.45 |
| 21 | −26.254 | 1.60 | | | 36.75 |
| 22 | −25.869 | 1.00 | 2.00100 | 29.1 | 36.40 |
| 23 | ∞ | 3.00 | 2.00069 | 25.5 | 43.24 |
| 24 | −125.535 | −3.00 | | | 44.09 |
| 25 | ∞ | 3.00 | | | 44.15 |
| 26 | −125.535 | (Variable) | | | 44.21 |
| 27 | ∞ | 1.00 | 1.51633 | 64.1 | 50.00 |
| 28 | ∞ | (Variable) | | | 50.00 |
| Image Plane | ∞ | | | | |

ASPHERIC DATA
4th Surface
K = −9.69697e−01 A 4 = 6.81233e−07 A 6 = −1.55549e−10 A 8 = 1.32810e−13
8th Surface
K = 0.00000e+00 A 4 = −3.32737e−06 A 6 = −2.58459e−09 A 8 = −2.84899e−12
14th Surface
K = 0.00000e+00 A 4 = 4.05263e−06 A 6 = 9.13264e−10
16th Surface
K = 0.00000e+00 A 4 = 5.81408e−07 A 6 = −1.96531e−09

VARIOUS DATA
ZOOM RATIO 1.40

| | WIDE | MIDDLE | TELE |
|---|---|---|---|
| Focal Length | 25.01 | 30.00 | 34.99 |
| Fno | 1.24 | 1.24 | 1.24 |
| Half Angle of View (°) | 37.96 | 33.46 | 29.93 |
| Image Height | 19.51 | 19.83 | 20.15 |
| Overall Lens Length | 163.41 | 141.33 | 126.34 |
| BF (in air) | 14.01 | 14.01 | 14.01 |
| d6 | 33.25 | 16.19 | 2.00 |
| d7 | 14.71 | 7.06 | 3.54 |
| d15 | 0.00 | 0.39 | 0.87 |
| d17 | 1.00 | 3.23 | 5.47 |
| d26 | 12.85 | 12.85 | 12.85 |
| d28 | 0.50 | 0.50 | 0.50 |

ZOOM LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −95.10 | 27.91 | 1.34 | −20.86 |
| 2 | 7 | ∞ | 0.00 | 0.00 | −0.00 |
| 3 | 8 | 81.45 | 34.45 | 0.41 | −28.74 |
| 4 | 16 | 50.26 | 8.63 | 3.91 | −2.01 |
| 5 | 18 | 83.23 | 29.12 | 29.08 | 10.13 |
| 6 | 27 | ∞ | 1.00 | 0.33 | −0.33 |

SINGLE LENS DATA

| Lens | Starting Surface | Focal Length |
|---|---|---|
| 1 | 1 | −82.80 |
| 2 | 3 | −82.77 |
| 3 | 5 | 72.07 |
| 4 | 8 | 114.68 |
| 5 | 11 | 73.00 |
| 6 | 13 | −92.08 |
| 7 | 16 | 50.26 |
| 8 | 18 | 48.25 |
| 9 | 19 | −22.89 |
| 10 | 20 | 37.49 |
| 11 | 22 | −25.84 |
| 12 | 23 | 125.45 |
| 13 | 24 | 125.45 |
| 14 | 25 | 125.45 |
| 15 | 27 | 0.00 |

NUMERICAL EXAMPLE 8
UNIT: mm
SURFACE DATA

| Surface No. | r | d | nd | νd | Effective Diameter |
|---|---|---|---|---|---|
| 1 | 82.906 | 1.50 | 2.00330 | 28.3 | 60.19 |
| 2 | 47.948 | 12.23 | | | 55.60 |
| 3 | −280.351 | 1.50 | 1.72916 | 54.1 | 54.42 |
| 4 | 172.581 | 0.71 | | | 53.27 |
| 5 | 77.195 | 7.52 | 1.85478 | 24.8 | 52.67 |
| 6 | −224.262 | 1.81 | | | 52.08 |
| 7 | −117.811 | 1.50 | 1.95375 | 32.3 | 51.54 |
| 8 | −1484.341 | (Variable) | | | 50.43 |
| 9* | 43.712 | 10.42 | 1.49710 | 81.6 | 53.30 |
| 10 | −214.406 | 3.00 | | | 53.19 |
| 11 (SP) | ∞ | 3.27 | | | 52.12 |
| 12 | 45.679 | 12.76 | 1.49700 | 81.5 | 49.68 |
| 13 | −91.143 | 3.24 | | | 48.48 |
| 14 | 231.687 | 1.50 | 2.00100 | 29.1 | 38.15 |
| 15* | 41.564 | 7.09 | | | 34.47 |
| 16 | ∞ | (Variable) | | | 34.04 |
| 17* | 7841.280 | 4.89 | 1.53775 | 74.7 | 33.70 |
| 18 | −49.823 | (Variable) | | | 33.43 |
| 19 | 201.845 | 6.85 | 1.85026 | 32.3 | 33.45 |
| 20 | −31.488 | 1.50 | 1.76845 | 41.2 | 33.56 |
| 21 | 40.703 | 6.96 | 1.49700 | 81.5 | 33.87 |
| 22 | −261.989 | 5.31 | | | 34.49 |
| 23 | −44.129 | 1.00 | 2.00330 | 28.3 | 35.47 |
| 24 | ∞ | 3.00 | 1.92119 | 24.0 | 38.59 |
| 25 | −166.656 | −3.00 | | | 39.84 |
| 26 | ∞ | 3.00 | | | 40.17 |
| 27 | −166.656 | (Variable) | | | 40.51 |
| 28 | ∞ | 1.00 | 1.51633 | 64.1 | 50.00 |
| 29 | ∞ | (Variable) | | | 50.00 |
| Image Plane | ∞ | | | | |

ASPHERIC DATA
9th Surface
K = 0.00000e+00 A 4 = −2.13593e−06 A 6 = −1.31682e−09 A 8 = −1.13405e−12
15th Surface
K = 0.00000e+00 A 4 = 6.52079e−06 A 6 = −6.92491e−09
17th Surface
K = 0.00000e+00 A 4 = 3.32630e−06 A 6 = 6.16101e−09

VARIOUS DATA
ZOOM RATIO 1.36

| | WIDE | MIDDLE | TELE |
|---|---|---|---|
| Focal Length | 36.00 | 43.00 | 49.00 |
| Fno | 1.24 | 1.24 | 1.24 |
| Half Angle of View (°) | 28.19 | 25.16 | 22.93 |
| Image Height | 19.29 | 20.20 | 20.72 |
| Overall Lens Length | 171.50 | 147.73 | 133.49 |
| BF (in air) | 11.49 | 11.49 | 11.49 |
| d8 | 58.96 | 32.16 | 15.33 |
| d16 | 2.14 | 1.81 | 1.56 |
| d18 | 1.00 | 4.35 | 7.19 |
| d27 | 10.33 | 10.33 | 10.33 |
| d29 | 0.50 | 0.50 | 0.50 |

ZOOM LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −126.63 | 26.77 | 3.06 | −17.60 |
| 2 | 9 | 64.16 | 41.29 | −12.17 | −36.78 |
| 3 | 17 | 92.08 | 4.89 | 3.16 | −0.02 |
| 4 | 19 | 112.85 | 24.62 | 20.00 | −0.35 |
| 5 | 28 | ∞ | 1.00 | 0.33 | −0.33 |

SINGLE LENS DATA

| Lens | Starting Surface | Focal Length |
|---|---|---|
| 1 | 1 | −115.82 |
| 2 | 3 | −146.30 |
| 3 | 5 | 67.97 |
| 4 | 7 | −134.24 |
| 5 | 9 | 74.04 |
| 6 | 12 | 63.18 |
| 7 | 14 | −50.80 |
| 8 | 17 | 92.08 |
| 9 | 19 | 32.47 |
| 10 | 20 | −22.90 |
| 11 | 21 | 71.43 |
| 12 | 23 | −43.98 |
| 13 | 24 | 180.91 |
| 14 | 25 | 180.91 |
| 15 | 26 | 180.91 |
| 16 | 28 | 0.00 |

NUMERICAL EXAMPLE 9
UNIT: mm
SURFACE DATA

| Surface No. | r | d | nd | νd | Effective Diameter |
|---|---|---|---|---|---|
| 1 | 131.213 | 2.40 | 2.00069 | 25.5 | 74.00 |
| 2 | 68.682 | 8.94 | 1.72916 | 54.7 | 70.30 |
| 3 | 346.172 | 0.50 | | | 69.83 |
| 4 | 70.119 | 6.87 | 1.75500 | 52.3 | 65.99 |
| 5 | 230.471 | (Variable) | | | 65.51 |
| 6 | 78.661 | 1.50 | 1.78800 | 47.4 | 47.02 |
| 7 | 33.678 | 10.84 | | | 43.25 |
| 8* | −150.561 | 1.50 | 1.76802 | 49.2 | 43.35 |
| 9 | 114.246 | 0.45 | | | 44.03 |
| 10 | 60.690 | 10.89 | 1.74077 | 27.8 | 45.61 |
| 11 | −93.611 | 3.24 | | | 45.44 |
| 12 | −51.294 | 1.50 | 1.81600 | 46.6 | 45.04 |
| 13 | −342.865 | (Variable) | | | 46.36 |
| 14 (SP) | ∞ | (Variable) | | | 51.51 |
| 15* | 74.722 | 6.50 | 1.49710 | 81.6 | 54.75 |
| 16 | −379.157 | 2.54 | | | 54.94 |
| 17 | 81.670 | 13.12 | 1.49700 | 81.5 | 55.90 |
| 18 | −64.887 | 2.54 | | | 55.58 |
| 19 | 147.596 | 1.50 | 1.63540 | 23.9 | 46.44 |
| 20* | 59.113 | (Variable) | | | 43.47 |
| 21* | 671.400 | 8.06 | 1.55332 | 71.7 | 48.97 |
| 22 | −52.233 | (Variable) | | | 49.38 |
| 23 | 193.868 | 1.50 | 2.00330 | 28.3 | 47.89 |
| 24 | 77.484 | 3.55 | | | 47.12 |
| 25 | 665.553 | 5.14 | 1.49710 | 81.6 | 47.18 |
| 26* | −83.120 | 5.75 | | | 47.35 |
| 27 | −50.955 | 1.50 | 1.90525 | 35.0 | 47.01 |
| 28 | ∞ | 3.50 | 1.78472 | 25.7 | 50.12 |
| 29 | −172.444 | −3.50 | | | 50.86 |
| 30 | ∞ | 3.50 | | | 50.63 |
| 31 | −172.444 | (Variable) | | | 50.40 |
| 32 | ∞ | 1.00 | 1.51633 | 64.1 | 50.00 |
| 33 | ∞ | (Variable) | | | 50.00 |
| Image Plane | ∞ | | | | |

ASPHERIC DATA
8th Surface
K = 0.00000e+00 A 4 = 4.09477e−07 A 6 = 1.99886e−10 A 8 = 6.08231e−13
15th Surface
K = 0.00000e+00 A 4 = −1.01011e−06 A 6 = −1.56970e−09 A 8 = −2.18854e−14
20th Surface
K = 0.00000e+00 A 4 = 3.32477e−06 A 6 = 1.01917e−09
21st Surface
K = 0.00000e+00 A 4 = −7.69683e−07 A 6 = 8.64044e−10
26th Surface
K = 0.00000e+00 A 4 = 1.13781e−07 A 6 = 1.32293e−10

VARIOUS DATA
ZOOM RATIO 1.60

| | WIDE | MIDDLE | TELE |
|---|---|---|---|
| Focal Length | 51.50 | 64.34 | 82.51 |
| Fno | 1.20 | 1.20 | 1.20 |
| Half Angle of View (°) | 22.79 | 18.59 | 14.69 |
| Image Height | 21.64 | 21.64 | 21.64 |
| Overall Lens Length | 180.50 | 174.98 | 176.93 |
| BF (in air) | 12.32 | 12.32 | 12.32 |
| d5 | 0.31 | 11.06 | 26.20 |
| d13 | 25.14 | 16.13 | 10.20 |
| d14 | 6.50 | 1.97 | 1.31 |
| d20 | 24.85 | 22.35 | 21.73 |
| d22 | 7.21 | 6.99 | 1.00 |
| d31 | 11.16 | 11.16 | 11.16 |
| d33 | 0.50 | 0.50 | 0.50 |

ZOOM LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | 110.00 | 18.71 | 2.35 | −8.42 |
| 2 | 6 | −51.13 | 29.92 | 7.60 | −13.72 |
| 3 | 14 | ∞ | 0.00 | 0.00 | 0.00 |
| 4 | 15 | 65.43 | 26.20 | 2.93 | −15.82 |
| 5 | 21 | 87.93 | 8.06 | 4.83 | −0.38 |
| 6 | 23 | 118.24 | 20.95 | 28.15 | 10.76 |
| 7 | 32 | ∞ | 1.00 | 0.33 | −0.33 |

SINGLE LENS DATA

| Lens | Starting Surface | Focal Length |
|---|---|---|
| 1 | 1 | −146.84 |
| 2 | 2 | 115.93 |
| 3 | 4 | 131.07 |
| 4 | 6 | −75.85 |
| 5 | 8 | −84.37 |
| 6 | 10 | 51.24 |
| 7 | 12 | −74.09 |
| 8 | 15 | 126.17 |
| 9 | 17 | 74.98 |
| 10 | 19 | −156.21 |
| 11 | 21 | 87.93 |
| 12 | 23 | −129.48 |
| 13 | 25 | 148.98 |
| 14 | 27 | −56.29 |
| 15 | 28 | 219.75 |
| 16 | 29 | 219.75 |
| 17 | 30 | 219.75 |
| 18 | 32 | 0.00 |

NUMERICAL EXAMPLE 10
UNIT: mm
SURFACE DATA

| Surface No. | r | d | nd | νd | Effective Diameter |
|---|---|---|---|---|---|
| 1 | 142.069 | 2.40 | 2.00069 | 25.5 | 68.50 |
| 2 | 66.558 | 8.65 | 1.67790 | 55.3 | 65.09 |
| 3 | 576.692 | 0.50 | | | 64.66 |
| 4 | 62.418 | 6.01 | 1.78800 | 47.4 | 60.22 |
| 5 | 170.503 | (Variable) | | | 59.50 |
| 6 | 110.473 | 1.50 | 1.77250 | 49.6 | 39.84 |
| 7 | 35.677 | 6.70 | | | 37.64 |
| 8* | −180.308 | 1.50 | 1.76802 | 49.2 | 37.71 |
| 9 | 136.211 | 0.48 | | | 38.33 |
| 10 | 58.865 | 11.64 | 1.72151 | 29.2 | 39.71 |
| 11 | −73.590 | 2.07 | | | 39.63 |
| 12 | −49.898 | 1.50 | 1.83481 | 42.7 | 39.29 |
| 13 | −353.817 | (Variable) | | | 40.08 |
| 14 (SP) | ∞ | (Variable) | | | 40.87 |
| 15* | 68.326 | 5.36 | 1.49710 | 81.6 | 43.04 |
| 16 | −200.750 | 3.25 | | | 43.06 |
| 17 | 56.773 | 8.45 | 1.49700 | 81.5 | 42.44 |
| 18 | −75.641 | 3.25 | | | 42.01 |
| 19 | 244.132 | 1.50 | 1.63540 | 23.9 | 36.15 |
| 20* | 55.164 | (Variable) | | | 34.00 |
| 21* | 315.543 | 6.65 | 1.55332 | 71.7 | 43.38 |
| 22 | −52.972 | (Variable) | | | 43.77 |
| 23 | 95.103 | 1.50 | 2.00069 | 25.5 | 42.99 |
| 24 | 52.813 | 1.64 | | | 42.05 |
| 25 | 80.038 | 6.90 | 1.61340 | 44.3 | 42.08 |
| 26* | −148.434 | 7.04 | | | 42.05 |
| 27 | −36.126 | 1.00 | 1.91650 | 31.6 | 40.02 |
| 28 | 182.394 | 1.81 | 1.88202 | 37.2 | 43.10 |
| 29 | ∞ | −1.81 | | | 43.31 |
| 30 | 182.394 | 1.81 | | | 43.50 |
| 31 | ∞ | 0.50 | 1.51633 | 64.1 | 43.45 |
| 32 | ∞ | (Variable) | | | 43.39 |
| Image Plane | ∞ | | | | |

ASPHERIC DATA
8th Surface
K = 0.00000e+00 A 4 = 3.43387e−07 A 6 = 4.32489e−10 A 8 = 6.35316e−13
15th Surface
K = 0.00000e+00 A 4 = −1.35390e−06 A 6 = −1.83822e−09 A 8 = 9.03689e−14
20th Surface
K = 0.00000e+00 A 4 = 3.59093e−06 A 6 = 9.83623e−10
21st Surface
K = 0.00000e+00 A 4 = −1.88335e−06 A 6 = 9.09329e−10
26th Surface
K = 0.00000e+00 A 4 = −6.13989e−06 A 6 = −4.79014e−10

VARIOUS DATA
ZOOM RATIO 1.60

| | WIDE | MIDDLE | TELE |
|---|---|---|---|
| Focal Length | 51.50 | 64.00 | 82.52 |
| Fno | 1.44 | 1.44 | 1.44 |
| Half Angle of View (°) | 22.79 | 18.68 | 14.69 |
| Image Height | 21.64 | 21.64 | 21.64 |
| Overall Lens Length | 156.83 | 151.14 | 156.37 |
| BF (in air) | 3.37 | 3.37 | 3.37 |
| d5 | 1.35 | 13.41 | 28.99 |
| d13 | 23.74 | 12.43 | 8.52 |
| d14 | 6.02 | 2.60 | 1.00 |
| d20 | 23.54 | 21.73 | 24.57 |
| d22 | 9.89 | 8.68 | 1.00 |
| d32 | 0.50 | 0.50 | 0.50 |

ZOOM LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | 109.52 | 17.56 | 3.01 | −7.20 |
| 2 | 6 | −58.36 | 25.39 | 4.81 | −12.56 |
| 3 | 14 | ∞ | 0.00 | 0.00 | 0.00 |
| 4 | 15 | 59.13 | 21.80 | 0.40 | −15.27 |
| 5 | 21 | 82.50 | 6.65 | 3.69 | −0.62 |
| 6 | 23 | −6334.37 | 20.39 | −200.09 | −225.15 |

SINGLE LENS DATA

| Lens | Starting Surface | Focal Length |
|---|---|---|
| 1 | 1 | −127.16 |
| 2 | 2 | 110.24 |
| 3 | 4 | 121.96 |
| 4 | 6 | −68.81 |
| 5 | 8 | −100.82 |
| 6 | 10 | 47.06 |
| 7 | 12 | −69.74 |
| 8 | 15 | 103.23 |
| 9 | 17 | 66.67 |
| 10 | 19 | −112.51 |
| 11 | 21 | 82.50 |
| 12 | 23 | −120.83 |
| 13 | 25 | 85.76 |
| 14 | 27 | −32.83 |
| 15 | 28 | 206.79 |
| 16 | 29 | 206.79 |
| 17 | 30 | 206.79 |
| 18 | 31 | 0.00 |

NUMERICAL EXAMPLE 11
UNIT: mm
SURFACE DATA

| Surface No. | r | d | nd | νd | Effective Diameter |
|---|---|---|---|---|---|
| 1 | 41.238 | 8.16 | 1.49700 | 81.5 | 25.00 |
| 2* | 143.259 | 4.37 | | | 23.70 |
| 3* | 84.062 | 2.47 | 1.76802 | 49.2 | 22.37 |
| 4* | 46.408 | 2.17 | | | 22.19 |
| 5 (SP) | ∞ | 5.00 | | | 22.24 |
| 6* | 336.902 | 13.20 | 1.49700 | 81.5 | 22.41 |
| 7* | −25.213 | 1.31 | | | 29.98 |
| 8 | −67.450 | 1.00 | 1.88300 | 40.8 | 33.04 |
| 9 | ∞ | 1.98 | 1.49700 | 81.5 | 34.94 |
| 10 | −126.165 | −1.98 | | | 35.52 |
| 11 | ∞ | 1.98 | | | 35.66 |
| 12 | −126.165 | 21.65 | | | 35.81 |
| 13 | ∞ | 1.00 | 1.51633 | 64.1 | 40.39 |
| 14 | ∞ | 0.50 | | | 40.55 |
| Image Plane | ∞ | | | | |

ASPHERIC DATA
1st Surface
K = 0.00000e+00 A 4 = −5.98397e−08 A 6 = −4.69065e−09
2nd Surface
K = 0.00000e+00 A 4 = −1.72753e−05 A 6 = 6.66460e−09
3rd Surface
K = 0.00000e+00 A 4 = −7.97584e−05 A 6 = 1.55610e−07 A 8 = 5.12331e−12
4th Surface
K = 0.00000e+00 A 4 = −6.47253e−05 A 6 = 1.88884e−07
6th Surface
K = 0.00000e+00 A 4 = −8.81099e−06 A 6 = 6.90546e−09
7th Surface
K = 0.00000e+00 A 4 = 1.10940e−06 A 6 = −5.37594e−09

VARIOUS DATA

| | |
|---|---|
| ZOOM RATIO | 1.00 |
| Focal Length | 32.50 |
| Fno | 1.30 |
| Half Angle of View (°) | 31.19 |
| Image Height | 19.68 |
| Overall Lens Length | 62.82 |
| BF (in air) | 22.81 |

SINGLE LENS DATA

| Lens | Starting Surface | Focal Length |
|---|---|---|
| 1 | 1 | 113.50 |
| 2 | 3 | −138.86 |
| 3 | 6 | 47.78 |
| 4 | 8 | −76.39 |
| 5 | 9 | 253.85 |
| 6 | 10 | 253.85 |
| 7 | 11 | 253.85 |
| 8 | 13 | 0.00 |

NUMERICAL EXAMPLE 12
UNIT: mm
SURFACE DATA

| Surface No. | r | d | nd | νd | Effective Diameter |
|---|---|---|---|---|---|
| 1* | 33.057 | 4.67 | 1.49700 | 81.5 | 19.13 |
| 2* | 219.507 | 4.76 | | | 16.76 |
| 3* | 349.408 | 2.76 | 1.76802 | 49.2 | 15.56 |
| 4* | 42.910 | 1.69 | | | 15.33 |
| 5 (SP) | ∞ | 5.00 | | | 15.41 |
| 6* | −382.974 | 9.91 | 1.49700 | 81.5 | 17.16 |
| 7* | −21.374 | 7.90 | | | 23.37 |
| 8 | −76.290 | 1.00 | 1.88300 | 40.8 | 32.20 |
| 9 | ∞ | 1.82 | 1.49700 | 81.5 | 33.88 |
| 10 | −135.143 | −1.82 | | | 34.45 |
| 11 | ∞ | 1.82 | | | 34.63 |
| 12 | −135.143 | 21.81 | | | 34.80 |
| 13 | ∞ | 1.00 | 1.51633 | 64.1 | 40.41 |
| 14 | ∞ | 0.50 | | | 40.57 |
| Image Plane | ∞ | | | | |

ASPHERIC DATA
1st Surface
K = 0.00000e+00 A 4 = 1.11113e−05 A 6 = 2.80371e−08
2nd Surface
K = 0.00000e+00 A 4 = 3.71379e−06 A 6 = −3.33873e−08
3rd Surface
K = 0.00000e+00 A 4 = −6.70571e−05 A 6 = 5.26611e−08 A 8 = 5.12331e−12
4th Surface
K = 0.00000e+00 A 4 = −4.86355e−05 A 6 = 1.74615e−07
6th Surface
K = 0.00000e+00 A 4 = −7.99779e−06 A 6 = 1.58276e−08
7th Surface
K = 0.00000e+00 A 4 = −1.62333e−06 A 6 = −9.03039e−09

VARIOUS DATA

| | |
|---|---|
| ZOOM RATIO | 1.00 |
| Focal Length | 35.00 |
| Fno | 2.00 |
| Half Angle of View(°) | 29.34 |
| Image Height | 19.67 |
| Overall Lens Length | 62.82 |
| BF (in air) | 22.97 |

SINGLE LENS DATA

| Lens | Starting Surface | Focal Length |
|---|---|---|
| 1 | 1 | 77.66 |
| 2 | 3 | −63.94 |
| 3 | 6 | 45.14 |
| 4 | 8 | −86.40 |
| 5 | 9 | 271.92 |
| 6 | 10 | 271.92 |
| 7 | 11 | 271.92 |
| 8 | 13 | 0.00 |

Table 1 summarizes a variety of values of each numerical example.

TABLE 1

| | | | | | | | Another | |
|---|---|---|---|---|---|---|---|---|
| | | | | | Variation | | Variation | |
| | | | Lower | Upper | Lower | Upper | Lower | Upper |
| | | | Limit | Limit | Limit | Limit | Limit | Limit |
| Inequality | (1) | L/Lh | 2.20 | 100.00 | 2.30 | 85.00 | 2.40 | 70.00 |
| | | L | | | | | | |
| | | Lh | | | | | | |
| | | D/LD | 0.15 | 2.00 | 0.21 | 1.50 | 0.25 | 1.00 |
| | | D | | | | | | |
| | | LD | | | | | | |
| | (2) | LD/L | 0.35 | 0.85 | 0.38 | 0.82 | 0.40 | 0.80 |
| | (3) | θ1/θ2 | 1.20 | 20.00 | 1.30 | 16.00 | 1.40 | 13.00 |
| | | θ1 | | | | | | |
| | | θ2 | | | | | | |
| | (4) | fP/f | 2.00 | 15.00 | 2.20 | 12.00 | 2.40 | 9.00 |
| | | f | | | | | | |
| | | fP | | | | | | |
| | (5) | nd | 1.45 | 2.30 | 1.47 | 2.20 | 1.49 | 2.10 |
| | (6) | L/Li | 1.00 | 200.00 | 2.00 | 185.00 | 2.50 | 170.00 |
| | | Li | | | | | | |
| | (7) | fN/fP | −1.00 | −0.10 | −0.80 | −0.12 | −0.75 | −0.15 |
| | | fN | | | | | | |
| | (8) | fN/f | −10.00 | −0.30 | −7.00 | −0.34 | −6.00 | −0.38 |
| | (9) | (R1 − R2)/ | −1.00 | 0.30 | −1.00 | 0.20 | −1.00 | 0.15 |
| | | (R1 + R2) | | | | | | |
| | | R1 | | | | | | |
| | | R2 | | | | | | |
| | (10) | fF/f | −30.00 | −0.30 | −25.00 | −0.40 | −20.00 | −0.45 |
| | | fF | | | | | | |
| | (11) | nd/ndN | 0.65 | 1.10 | 0.70 | 1.05 | 0.75 | 1.02 |
| | | ndN | | | | | | |
| | (12) | d/L | 0.01 | 0.15 | 0.01 | 0.12 | 0.01 | 0.09 |
| | | d | | | | | | |
| | (13) | Lh/f | 0.01 | 0.90 | 0.01 | 0.85 | 0.01 | 0.80 |
| | (14) | Oe/Ie | 0.30 | 4.00 | 0.40 | 3.00 | 0.50 | 2.00 |
| | | Oe | | | | | | |
| | | Ie | | | | | | |
| | (15) | Fno | 0.50 | 8.00 | 0.60 | 4.00 | 0.70 | 2.50 |

| | | | Example | | | | | |
|---|---|---|---|---|---|---|---|---|
| | | | 1 | 2 | 3 | 4 | 5 | 6 |
| Inequality | (1) | L/Lh | 6.87 | 5.60 | 5.12 | 5.07 | 8.14 | 8.65 |
| | | L | 75.29 | 74.46 | 68.71 | 80.01 | 133.09 | 159.85 |
| | | Lh | 10.97 | 13.30 | 13.43 | 15.79 | 16.34 | 18.49 |
| | | D/LD | 0.80 | 0.84 | 0.75 | 0.69 | 0.71 | 0.68 |
| | | D | 25.89 | 29.70 | 33.12 | 33.53 | 49.98 | 63.93 |
| | | LD | 32.48 | 35.27 | 44.05 | 48.82 | 69.92 | 93.54 |
| | (2) | LD/L | 0.43 | 0.47 | 0.64 | 0.61 | 0.53 | 0.59 |
| | (3) | θ1/θ2 | 4.79 | 2.46 | 2.90 | 2.86 | 2.75 | 10.21 |
| | | θ1 | 27.4 | 24.9 | 25.9 | 21.9 | 14.5 | 12.9 |
| | | θ2 | 5.7 | 10.1 | 8.9 | 7.7 | 5.3 | 1.3 |
| | (4) | fP/f | 7.49 | 6.81 | 5.01 | 4.19 | 3.86 | 2.80 |
| | | f | 18.19 | 24.02 | 35.02 | 50.99 | 82.92 | 97.10 |
| | | fP | 136.17 | 163.52 | 175.30 | 213.90 | 319.72 | 271.52 |
| | (5) | nd | 1.50 | 1.50 | 1.50 | 1.64 | 1.65 | 1.81 |
| | (6) | L/Li | 10.76 | 9.08 | 7.11 | 6.79 | 9.98 | 11.47 |
| | | Li | 7.00 | 8.20 | 9.66 | 11.79 | 13.34 | 13.94 |
| | (7) | fN/fP | −0.56 | −0.68 | −0.17 | −0.23 | −0.43 | −0.51 |
| | | fN | −75.74 | −110.69 | −29.37 | −49.86 | −137.59 | −137.81 |
| | (8) | fN/f | −4.16 | −4.61 | −0.84 | −0.98 | −1.66 | −1.42 |
| | (9) | (R1 − R2)/ | −0.0004 | 0.13 | −0.56 | −0.56 | −0.28 | −0.33 |
| | | (R1 + R2) | | | | | | |
| | | R1 | −67.63 | −106.16 | −24.51 | −38.81 | −116.99 | −110.96 |
| | | R2 | −67.67 | −81.27 | −87.12 | −136.85 | −207.08 | −218.87 |
| | (10) | fF/f | −9.90 | −15.40 | −1.03 | −1.30 | −2.95 | −2.95 |
| | | fF | −180.16 | −370.02 | −36.03 | −66.22 | −244.71 | −286.41 |
| | (11) | nd/ndN | 0.79 | 0.76 | 0.82 | 0.92 | 0.89 | 1.00 |
| | | ndN | 1.89 | 1.96 | 1.83 | 1.78 | 1.85 | 1.81 |
| | (12) | d/L | 0.07 | 0.08 | 0.07 | 0.06 | 0.03 | 0.03 |
| | | d | 4.97 | 6.10 | 4.77 | 5.00 | 4.00 | 5.55 |
| | (13) | Lh/f | 0.60 | 0.55 | 0.38 | 0.31 | 0.20 | 0.19 |
| | (14) | Oe/Ie | 1.46 | 1.28 | 0.93 | 1.05 | 1.71 | 1.84 |
| | | Oe | 62.1 | 55.6 | 43.7 | 51.5 | 82.5 | 96.3 |
| | | Ie | 42.4 | 43.5 | 46.8 | 49.0 | 48.2 | 52.3 |
| | (15) | Fno | 0.77 | 0.77 | 0.84 | 1.03 | 1.03 | 1.03 |

| | | | Example | | | | | |
|---|---|---|---|---|---|---|---|---|
| | | | 7 | | | 8 | | |
| | | | WIDE | MIDDLE | TELE | WIDE | MIDDLE | TELE |
| Inequality | (1) | L/Lh | 9.42 | 8.14 | 7.28 | 11.56 | 9.96 | 9.00 |
| | | L | 163.41 | 141.33 | 126.34 | 171.50 | 147.73 | 133.49 |
| | | Lh | 17.35 | 17.35 | 17.35 | 14.83 | 14.83 | 14.83 |
| | | D/LD | 0.49 | 0.49 | 0.49 | 0.65 | 0.66 | 0.67 |
| | | D | 36.17 | 37.49 | 38.82 | 46.97 | 49.67 | 52.12 |
| | | LD | 73.78 | 76.41 | 79.12 | 72.35 | 75.38 | 77.97 |
| | (2) | LD/L | 0.45 | 0.54 | 0.63 | 0.42 | 0.51 | 0.58 |
| | (3) | θ1/θ2 | 3.92 | 4.08 | 4.25 | 2.24 | 2.26 | 2.12 |
| | | θ1 | 22.6 | 22.9 | 23.2 | 17.0 | 17.2 | 32.1 |
| | | θ2 | 5.8 | 5.6 | 5.5 | 7.6 | 7.6 | 15.1 |
| | (4) | fP/f | 5.02 | 4.18 | 3.59 | 5.03 | 4.21 | 3.69 |
| | | f | 25.01 | 30.00 | 34.99 | 36.00 | 43.00 | 49.00 |
| | | fP | 125.45 | 125.45 | 125.45 | 180.91 | 180.91 | 180.91 |
| | (5) | nd | 2.00 | 2.00 | 2.00 | 1.92 | 1.92 | 1.92 |
| | (6) | L/Li | 11.39 | 9.85 | 8.80 | 14.50 | 12.49 | 11.28 |
| | | Li | 14.35 | 14.35 | 14.35 | 11.83 | 11.83 | 11.83 |
| | (7) | fN/fP | −0.21 | −0.21 | −0.21 | −0.24 | −0.24 | −0.24 |
| | | fN | −25.84 | −25.84 | −25.84 | −43.98 | −43.98 | −43.98 |
| | (8) | fN/f | −1.03 | −0.86 | −0.74 | −1.22 | −1.02 | −0.90 |
| | (9) | (R1 − R2)/ | −0.66 | −0.66 | −0.66 | −0.58 | −0.58 | −0.58 |
| | | (R1 + R2) | | | | | | |
| | | R1 | −25.87 | −25.87 | −25.87 | −44.13 | −44.13 | −44.13 |
| | | R2 | −125.54 | −125.54 | −125.54 | −166.66 | −166.66 | −166.66 |
| | (10) | fF/f | −1.33 | −1.11 | −0.95 | −1.64 | −1.37 | −1.20 |
| | | fF | −33.21 | −33.21 | −33.21 | −59.00 | −59.00 | −59.00 |
| | (11) | nd/ndN | 1.00 | 1.00 | 1.00 | 0.96 | 0.96 | 0.96 |
| | | ndN | 2.00 | 2.00 | 2.00 | 2.00 | 2.00 | 2.00 |
| | (12) | d/L | 0.02 | 0.03 | 0.03 | 0.02 | 0.03 | 0.03 |
| | | d | 4.00 | 4.00 | 4.00 | 4.00 | 4.00 | 4.00 |
| | (13) | Lh/f | 0.69 | 0.58 | 0.50 | 0.41 | 0.34 | 0.30 |
| | (14) | Oe/Ie | 1.60 | 1.60 | 1.60 | 1.46 | 1.46 | 1.46 |
| | | Oe | 74.0 | 74.0 | 74.0 | 62.2 | 62.2 | 62.2 |
| | | Ie | 46.2 | 46.2 | 46.2 | 42.5 | 42.5 | 42.5 |
| | (15) | Fno | 1.24 | 1.24 | 1.24 | 1.24 | 1.24 | 1.24 |

| | | | Example | | | | | | | |
|---|---|---|---|---|---|---|---|---|---|---|
| | | | 9 | | | 10 | | | | |
| | | | WIDE | MIDDLE | TELE | WIDE | MIDDLE | TELE | 11 | 12 |
| Inequality | (1) | L/Lh | 11.17 | 10.83 | 10.95 | 55.81 | 53.79 | 55.65 | 2.50 | 2.50 |
| | | L | 180.50 | 174.98 | 176.93 | 156.83 | 151.14 | 156.37 | 62.82 | 62.82 |
| | | Lh | 16.16 | 16.16 | 16.16 | 2.81 | 2.81 | 2.81 | 25.13 | 25.13 |
| | | D/LD | 0.48 | 0.52 | 0.53 | 0.45 | 0.48 | 0.51 | 0.49 | 0.31 |
| | | D | 51.00 | 51.43 | 48.85 | 39.89 | 39.43 | 38.69 | 22.24 | 15.41 |
| | | LD | 106.42 | 99.16 | 91.91 | 88.79 | 82.36 | 75.92 | 45.64 | 48.94 |
| | (2) | LD/L | 0.59 | 0.57 | 0.52 | 0.57 | 0.54 | 0.49 | 0.73 | 0.78 |
| | (3) | θ1/θ2 | 9.32 | 5.79 | 5.13 | 6.27 | 4.77 | 4.65 | 1.48 | 1.53 |
| | | θ1 | 15.4 | 16.1 | 16.3 | 15.6 | 16.6 | 16.7 | 18.8 | 17.9 |
| | | θ2 | 1.7 | 2.8 | 3.2 | 2.5 | 3.5 | 3.6 | 12.7 | 11.7 |
| | (4) | fP/f | 4.27 | 3.42 | 2.66 | 4.02 | 3.23 | 2.51 | 7.81 | 7.77 |
| | | f | 51.50 | 64.34 | 82.51 | 51.50 | 64.00 | 82.52 | 32.50 | 35.00 |
| | | fP | 219.75 | 219.75 | 219.75 | 206.79 | 206.79 | 206.79 | 253.85 | 271.92 |
| | (5) | nd | 1.78 | 1.78 | 1.78 | 1.88 | 1.88 | 1.88 | 1.50 | 1.50 |
| | (6) | L/Li | 14.26 | 13.82 | 13.98 | 156.83 | 151.14 | 156.37 | 2.71 | 2.69 |
| | | Li | 12.66 | 12.66 | 12.66 | 1.00 | 1.00 | 1.00 | 23.15 | 23.31 |
| | (7) | fN/fP | −0.26 | −0.26 | −0.26 | −0.16 | −0.16 | −0.16 | −0.30 | −0.32 |
| | | fN | −56.29 | −56.29 | −56.29 | −32.83 | −32.83 | −32.83 | −76.39 | −86.40 |
| | (8) | fN/f | −1.09 | −0.87 | −0.68 | −0.64 | −0.51 | −0.40 | −2.35 | −2.47 |
| | (9) | (R1 − R2)/ | −0.54 | −0.54 | −0.54 | −1.00 | −1.00 | −1.00 | −0.30 | −0.28 |
| | | (R1 + R2) | | | | | | | | |
| | | R1 | −50.96 | −50.96 | −50.96 | −36.13 | −36.13 | −36.13 | −67.45 | −76.29 |
| | | R2 | −172.44 | −172.44 | −172.44 | 1.0E+30 | 1.0E+30 | 1.0E+30 | −126.17 | −135.14 |
| | (10) | fF/f | −1.49 | −1.20 | −0.93 | −0.76 | −0.61 | −0.47 | −3.40 | −3.65 |
| | | fF | −76.97 | −76.97 | −76.97 | −39.12 | −39.12 | −39.12 | −110.42 | −127.84 |
| | (11) | nd/ndN | 0.94 | 0.94 | 0.94 | 0.98 | 0.98 | 0.98 | 0.80 | 0.80 |
| | | ndN | 1.91 | 1.91 | 1.91 | 1.92 | 1.92 | 1.92 | 1.88 | 1.88 |
| | (12) | d/L | 0.03 | 0.03 | 0.03 | 0.02 | 0.02 | 0.02 | 0.05 | 0.04 |
| | | d | 5.00 | 5.00 | 5.00 | 2.81 | 2.81 | 2.81 | 2.98 | 2.82 |
| | (13) | Lh/f | 0.31 | 0.25 | 0.20 | 0.05 | 0.04 | 0.03 | 0.77 | 0.72 |
| | (14) | Oe/Ie | 1.44 | 1.44 | 1.44 | 1.55 | 1.55 | 1.55 | 0.71 | 0.57 |
| | | Oe | 76.0 | 76.0 | 76.0 | 70.5 | 70.5 | 70.5 | 27.0 | 21.1 |
| | | Ie | 52.9 | 52.9 | 52.9 | 45.5 | 45.5 | 45.5 | 37.8 | 36.8 |
| | (15) | Fno | 1.20 | 1.20 | 1.20 | 1.44 | 1.44 | 1.44 | 1.30 | 2.00 |

### Image Pickup Apparatus

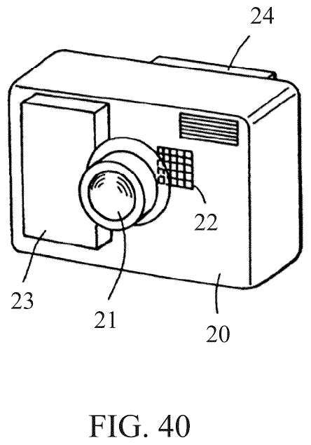

An image pickup apparatus including the imaging optical system according to any one of the above examples will be described. FIG. 40 is a schematic diagram of a digital camera as an example of the image pickup apparatus. Reference numeral 20 denotes a digital camera body, reference numeral 21 denotes an imaging optical system that is any one of the imaging optical systems of the above examples, and reference numeral 22 denotes an image sensor, such as a CCD, configured to receive an object image formed by the imaging optical system 21. Reference numeral 23 denotes a recorder configured to record the object image received by the image sensor 22, and reference numeral 24 denotes a viewfinder for observing the object image displayed on a display element (not illustrated).

The display element includes, for example, a liquid crystal panel, and displays the object image formed on the image sensor 22. Reference numeral 25 denotes a liquid crystal display panel having a function equivalent to that of the viewfinder 24.

Thus, applying the imaging optical system according to each example to an image pickup apparatus can achieve an image pickup apparatus that has a reduced size and high optical performance.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each example can provide an imaging optical system that has a reduced size, a large aperture, and high optical performance.

What is claimed is:

1. An imaging optical system comprising:
an aperture stop;
a first transmissive reflective surface;
a quarter waveplate; and
a second transmissive reflective surface,
wherein the first transmissive reflective surface, the quarter waveplate, and the second transmissive reflective surface are arranged in order from an object side to an image side,
wherein light from the object side sequentially transmits through the first transmissive reflective surface and the quarter waveplate, is reflected toward the object side by the second transmissive reflective surface, transmits through the quarter waveplate, is reflected toward the image side by the first transmissive reflective surface, and sequentially transmits through the quarter waveplate and the second transmissive reflective surface toward the image side, and
wherein the following inequalities are satisfied:
$$2. 2 \leq L / Lh \leq 100.$$
$$0.15 \leq D / LD \leq 2. 00$$
where L is an overall optical length, Lh is a distance on an optical axis from the first transmissive reflective surface to an image plane, D is a maximum aperture diameter of the aperture stop, and LD is a distance on the optical axis from the aperture stop to the image plane.

2. The imaging optical system according to claim 1, wherein the aperture stop is disposed closer to the image plane than a lens disposed closest to an object among lenses included in the imaging optical system, and
wherein the following inequality is satisfied:
$$0.35 \leq LD / L \leq 0.85 .$$

3. The imaging optical system according to claim 1, wherein the first transmissive reflective surface and the second transmissive reflective surface are disposed closer to the image plane than the aperture stop.

4. The imaging optical system according to claim 1, wherein the following inequality is satisfied:
$$1.2 \leq θ 1 / θ 2 \leq 20.00$$
where θ1 is an angle relative to the optical axis of an outermost off-axis ray passing through a center of the aperture stop and entering the first transmissive reflective surface, and θ2 is an angle relative to the optical axis of the outermost off-axis ray after being reflected by the second transmissive reflective surface and reflected by the first transmissive reflective surface.

5. The imaging optical system according to claim 1, wherein the second transmissive reflective surface is disposed adjacent to and closer to the image plane than the first transmissive reflective surface, and
wherein the following inequality is satisfied:
$$2. \leq fP / f \leq 15.$$
where fP is a focal length of a structure surrounded by the first transmissive reflective surface and the second transmissive reflective surface, and f is a focal length of the imaging optical system.

6. The imaging optical system according to claim 1, wherein space between the first transmissive reflective surface and the second transmissive reflective surface is filled with a material other than air, and
wherein the following inequality is satisfied:
$$1. 45 \leq nd \leq 2.30$$
where nd is a refractive index of the material.

7. The imaging optical system according to claim 1, wherein the following inequality is satisfied:
$$1. \leq L / Li \leq 200.00$$
where Li is a distance on the optical axis from the second transmissive reflective surface to the image plane.

8. The imaging optical system according to claim 1, wherein the second transmissive reflective surface is a lens surface disposed closest to the image plane in the imaging optical system.

9. The imaging optical system according to claim 1, further comprising a negative lens disposed adjacent to and closer to an object than the first transmissive reflective surface,
wherein the second transmissive reflective surface is disposed adjacent to and closer to the image plane than the first transmissive reflective surface, and
wherein the following inequality is satisfied:
$$- 1. \leq fN / fP \leq - 0.1$$
where fN is a focal length of the negative lens, and fP is a focal length of a structure surrounded by the first transmissive reflective surface and the second transmissive reflective surface.

10. The imaging optical system according to claim 1, further comprising a negative lens disposed adjacent to and closer to object than the first transmissive reflective surface,
wherein the following inequality is satisfied:
$$- 10. \leq fN / f \leq - 0.3$$
where fN is a focal length of the negative lens, and f is a focal length of the imaging optical system.

11. The imaging optical system according to claim 1, further comprising a negative lens disposed adjacent to and closer to object than the first transmissive reflective surface,
wherein the following inequality is satisfied:
$$- 1. \leq ( R 1 - R 2 ) / ( R 1 + R 2 ) \leq 0.30$$
where R1 is a radius of curvature of an object-side lens surface of the negative lens, and R2 is a radius of curvature of the second transmissive reflective surface.

12. The imaging optical system according to claim 1, further comprising a negative lens disposed adjacent to and closer to the object than the first transmissive reflective surface,
wherein the following inequality is satisfied:
$$- 30. \leq fF / f \leq - 0.3$$
where fF is a focal length from an object-side lens surface of the negative lens to the second transmissive reflective surface, and f is a focal length of the imaging optical system.

13. The imaging optical system according to claim 1, further comprising a negative lens disposed adjacent to and closer to the object than the first transmissive reflective surface,
wherein space between the first transmissive reflective surface and the second transmissive reflective surface is filled with a material other than air, and
wherein the following inequality is satisfied:
$$0.65 \leq nd / ndN \leq 1.10$$
where nd is a refractive index of the material, and ndN is a refractive index of the negative lens.

14. The imaging optical system according to claim 1, further comprising a negative lens disposed adjacent to and closer to the object than the first transmissive reflective surface,
wherein the following inequality is satisfied:
$$0.01 \leq d / L \leq 0.15$$
where d is a distance on the optical axis from an object-side lens surface of the negative lens to the second transmissive reflective surface.

15. The imaging optical system according to claim 1, further comprising a negative lens disposed adjacent to and closer to the object than the first transmissive reflective surface,
wherein no air gap exists between an object-side lens surface of the negative lens and the second transmissive reflective surface.

16. The imaging optical system according to claim 1, wherein the following inequality is satisfied:
$$0.01 \leq Lh / f \leq 0.90$$
where f is a focal length of the imaging optical system.

17. The imaging optical system according to claim 1, wherein the following inequality is satisfied:
$$0.3 \leq Oe / Ie \leq 4.00$$
where Oe is an outer diameter of a lens disposed closest to an object, and Ie is an outer diameter of a lens disposed closest to the image plane.

18. The imaging optical system according to claim 1, wherein the following inequality is satisfied:
$$0.5 \leq Fno \leq 8.$$
where Fno is an F-number of the imaging optical system.

19. An imaging optical system comprising:
an aperture stop;
a first transmissive reflective surface;
a quarter waveplate, and
a second transmissive reflective surface,
wherein the first transmissive reflective surface, the quarter waveplate, and the second transmissive reflective surface are arranged in order from an object side to an image side,
wherein light from the object side sequentially transmits through the first transmissive reflective surface and the quarter waveplate, is reflected toward the object side by the second transmissive reflective surface, transmits through the quarter waveplate, is reflected toward the image side by the first transmissive reflective surface, and sequentially transmits through the quarter waveplate and the second transmissive reflective surface toward the image side.

20. An image pickup apparatus comprising:
the imaging optical system according to claim 1; and
an image sensor configured to receive image light formed by the imaging optical system.
